(19) United States
(12) Patent Application Publication
(10) Pub. No.: US 2015/0248526 A1
(43) Pub. Date: Sep. 3, 2015

(54) Method for Preparing a Patient for Colonoscopy Procedures

(71) Applicant: Paul Choi, Los Angeles, CA (US)

(72) Inventor: Paul Choi, Los Angeles, CA (US)

(21) Appl. No.: 14/518,908

(22) Filed: Oct. 20, 2014

Related U.S. Application Data
(60) Provisional application No. 61/946,014, filed on Feb. 28, 2014.

(51) Int. Cl. G06F 19/00; H04M 1/725

(52) U.S. Cl. CPC G06F 19/325; G06F 19/327; G06F 19/322; H04M 1/72522

(57) ABSTRACT

The preferred embodiment of the invention features a method for preparing a patient for a medical procedure. In particular, the preferred embodiment provides a method for preparing a patient for a medical procedure for colonoscopy using an application on a mobile communication device. More particularly, the preferred embodiment provides a method for instructionally reminding to a patient on its mobile communication device using said application for all the steps involved in colonoscopy procedure at appropriate time point. Furthermore, preferred embodiment provides a method for multimedia instructional reminder simultaneously to a patient on its mobile communication device using said application for colonoscopy procedure.

### CROSS-REFERENCE TO RELATED APPLICATIONS

This application claims the benefit of U.S. Provisional Application No. 61/946,014 filed Feb. 28, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present application generally relates to the field of mobile applications for medical procedures. Particularly, the application provides a method for preparing a patient for a medical procedure using mobile software.

### BACKGROUND OF THE INVENTION

Colonoscopies represent the single most ubiquitous and important method for the screening and early identification of various diseases associated with the large intestines. The seriousness of diseases associated with the large intestines evidences the importance of colonoscopies. Colorectal cancer, for instance, remains the second leading cause of cancer-related death in the U.S. Other diseases that affect the large intestines include ulcerative colitis, diverticulitis, and Crohn's disease.

Each year, medical professionals perform over 12 million colonoscopies in the United States. Colonoscopies help to diagnose the various diseases associated with the large intestines. One particularly relevant study, Screening and surveillance for colorectal cancer: state of the art (Kahi C J, Anderson J C, Rex D K. Gastrointest Endosc. 2013; 77: 335-50.), reported that a patient cohort that received colonoscopies showed 65% and 67% reduction in morbidity and mortality, respectively, as compared to a control group.

Despite the prevalence and importance of colonoscopies in diagnosis and prevention of colorectal cancer, there are challenges associated with obtaining a clear prognosis. Specifically, the colonoscopy preparation process is highly important for a colonoscopy; a poorly prepared colon can lead to indeterminate diagnoses for diseases associated with the large intestines. The degree to which the patient complies with the colonoscopy preparation process can affect the effectiveness of the proceeding colonoscopy examination.

The colonoscopy preparation process is a time-intensive, highly complex and intricate process compared to other standard and routinely performed medical procedures. Often, patients do not fully adhere to the required preparation regimen. Commonplace occurrences of sub-optimal preparation of the colonic mucosa due to an inadequate or improper cleansing and removal of fecal matter regularly lead to inconclusive findings upon initial examination. This leads to misdiagnosis, repeat subsequent colonoscopies, and/or possibly necessitating more frequent colonoscopies performed in shorter intervals.

In general, a number of factors must be considered for effective bowel preparation, including, but not limited to: proper disclosure of the colonoscopy preparation process to the patient, the diagnosis and/or disclosure of medical conditions that may affect procedures within the colonoscopy preparation process, the proper bowel cleansing agent or proper bowel-cleansing medication and its dosage, and dietary restrictions prior to the colonoscopy. In addition, colonoscopies are generally performed in intervals of several years to a decade, and the procedure is easily forgotten during said interval. As a result of the complexity and infrequency associated with the colonoscopy preparation process, medical professionals and patients must allocate excessive financial and human resources toward educating patients in relation to the colonoscopy preparation process.

The most commonplace prior art methods associated with the distribution of information regarding the bowel preparation process prior to a colonoscopy typically comprise a set of written or oral instructions to the patient. Medical professionals often must remind patients about appointment in person. Additional reminder notifications are sent to the patient either via email or phone, which may end up being inconvenient for both the health-care practitioner and the patient. Apart from these inconveniences, however, there are certain drawbacks and/or constraints associated with conventional solutions that remain unaddressed.

A drawback associated with prior art methods is the difficulty in effectively communicating the sequence of sub-processes that are required in performing the colonoscopy preparation process. In general, said prior art methods do not effectively communicate which steps need to be performed at which time point during the colonoscopy preparation process. Reminders for instructions for said sub-processes are typically conveyed by written or spoken communication. Such communication has limitations, including, but not limited to ill-timed conveying of said communication, confusion associated with written or verbal instructions, and possibly incorrectly performing or not performing the sub-processes due to miscommunication or memory lapses. It is relevant to mention that there are many elderly patients undergoing colonoscopies, and written instructions may be difficult to follow, for example, particularly when said elderly patients are affected by poor vision.

Thus, in light of the aforementioned prior art, it is evident that there is a need for a method to simplify and facilitate the colonoscopy preparation process to a patient. There is also a need for a method that clearly discloses the sub-processes that are comprised in said colonoscopy preparation process. Said method for preparing a patient for a medical procedure, such as a colonoscopy, is communicated through software on a patient's mobile communication platform.

### SUMMARY

The primary objective of the preferred embodiment of the invention is to provide a method for preparing a patient for a medical procedure for colonoscopy using an application on a mobile communication device. Said method delivers reminders to a patient on its mobile communication device using said application for all the steps involved in colonoscopy procedure at appropriate time point.

In an alternative embodiment of the invention, the method incorporates steps to deliver multimedia instructional reminders simultaneously to a patient on a mobile communication device using a mobile application, wherein the multimedia instructional reminders comprise any or all of text reminders, graphic illustration reminders, and voice reminder. The above described method may also be used for many other medical procedures, other instructional or educational tasks.

### BRIEF DESCRIPTION OF THE DRAWINGS

FIG. 1. A flow-diagram of the Medical Instruction App software-related invention embodiment.

FIG. 2. Display of the Medical Information Disclaimer and Legal Agreement on a processor-based device in an embodiment of the invention.

FIG. 3A. Display of the Prompt for User's date and time of the medical examination in an embodiment of the invention.

FIG. 3B. Display of the Prompt for User medication information in an embodiment of the invention.

FIG. 3C. Display of the Prompt for User's Bowel Preparation Medication in an embodiment of the invention.

FIG. 4. Flow Diagram of the Scheduling Algorithm embodiment

FIG. 5. The Home informational material embodiment in the Medical Instruction App in a processor-based device.

FIG. 6. The My Schedule informational material embodiment in the Medical Instruction App in a processor-based device.

FIG. 7. The Edit My Schedule informational material embodiment in the Medical Instruction App in a processor-based device.

FIG. 8. The FAQs informational material embodiment in the Medical Instruction App in a processor-based device.

FIG. 9. The Images informational material embodiment in the Medical Instruction App in a processor-based device.

FIG. 10. Text, Audio, and/or Visual Display embodiment in a processor-based device.

FIG. 11A. English, Spanish, and Korean text translation embodiment.

FIG. 11B. English, Spanish, and Korean text translation embodiment.

FIG. 11C. English, Spanish, and Korean text translation embodiment.

FIG. 11D. English, Spanish, and Korean text translation embodiment.

FIG. 11E. English, Spanish, and Korean text translation embodiment.

FIG. 11F. English, Spanish, and Korean text translation embodiment.

FIG. 11G. English, Spanish, and Korean text translation embodiment.

FIG. 11H. English, Spanish, and Korean text translation embodiment.

FIG. 11I. English, Spanish, and Korean text translation embodiment.

FIG. 11J. English, Spanish, and Korean text translation embodiment.

FIG. 11K. English, Spanish, and Korean text translation embodiment.

FIG. 11L. English, Spanish, and Korean text translation embodiment.

FIG. 11M. English, Spanish, and Korean text translation embodiment.

FIG. 11N. English, Spanish, and Korean text translation embodiment.

FIG. 11O. English, Spanish, and Korean text translation embodiment.

FIG. 11P. English, Spanish, and Korean text translation embodiment.

FIG. 11Q. English, Spanish, and Korean text translation embodiment.

FIG. 11R. English, Spanish, and Korean text translation embodiment.

FIG. 12A. English, Spanish, and Korean text translation embodiment.

FIG. 12B. English, Spanish, and Korean text translation embodiment.

FIG. 12C. English, Spanish, and Korean text translation embodiment.

FIG. 12D. English, Spanish, and Korean text translation embodiment.

FIG. 12E. English, Spanish, and Korean text translation embodiment.

FIG. 12F. English, Spanish, and Korean text translation embodiment.

FIG. 13A. English, Spanish, and Korean text translation embodiment.

FIG. 13B. English, Spanish, and Korean text translation embodiment.

FIG. 13C. English, Spanish, and Korean text translation embodiment.

FIG. 13D. English, Spanish, and Korean text translation embodiment.

FIG. 13E. English, Spanish, and Korean text translation embodiment.

FIG. 13F. English, Spanish, and Korean text translation embodiment.

FIG. 13G. English, Spanish, and Korean text translation embodiment.

FIG. 13H. English, Spanish, and Korean text translation embodiment.

FIG. 13I. English, Spanish, and Korean text translation embodiment.

FIG. 13J. English, Spanish, and Korean text translation embodiment.

FIG. 13K. English, Spanish, and Korean text translation embodiment.

### NUMERICAL REFERENCES

101. Startup of the software-related Medical Instruction App embodiment
102. Prompt for a medical information disclaimer and legal agreement embodiment
103. Prompt and User Input for information regarding the anticipated medical procedure embodiment
104. Prompt for User's date and time of the medical examination embodiment
105. Prompt for User medication information embodiment
106. Prompt for User's Bowel Preparation Medication embodiment
107. Scheduling Algorithm embodiment
108. Data storage medium or memory storage found in the prior art
109. Medical Instruction App Menu embodiment
110. Home informational material Menu Item embodiment
111. My Schedule informational material Menu Item embodiment
112. Edit My Schedule informational material Menu Item embodiment
113. FAQs informational material Menu Item embodiment
114. Images informational material Menu Item embodiment
115. My Schedule informational material embodiment
116. FAQs informational material embodiment
117. Images informational material embodiment
118. Reminder Notifications activated at designated date and time embodiment
119. Text, Audio, and/or Visual Display and interactive interface embodiment
120. Syncing Module with other software in the preferred embodiment of the invention
121. Re-execution of the Prompt for User information regarding the anticipated medical procedure embodiment
122. Home Informational Material embodiment
123. User Input for Date and Time in the preferred embodiment of the invention
124. User Input for Medication Information in the preferred embodiment of the invention
125. User Input for Bowel Preparation Medication in the preferred embodiment of the invention
201. Display of medical information disclaimer and legal agreement embodiment
202. Selection prompt for accepting the terms of the medical information disclaimer and legal agreement in the preferred embodiment
203. Selection prompt for declining the terms of the medical information disclaimer and legal agreement in the preferred embodiment
204. A processor-based device, as found in the prior art
205. Audio presentation of the medical information disclaimer and legal agreement embodiment
301. Prompt for the Date embodiment
302. Prompt for the Time embodiment
303. Prompt to Continue and Save embodiment
304. Prompt for blood thinner embodiment
305. Prompt for diabetes medication embodiment
306. Prompt for iron supplements embodiment
307. User-selectable “yes” interface embodiment
308. User-selectable “no” interface embodiment
309. Visual Aid embodiment
310. User Selectable Bowel Preparation Medication Prompt
401. Date and Time Reminders, based on User Input of date and time of the medical examination in the preferred embodiment of the invention
402. Medication Information Reminders in the preferred embodiment of the invention
403. An example process in the case where the User Input for Bowel Preparation Medication is Golytely®
404. Bowel Preparation Medication Reminder in the preferred embodiment of the invention
405. Reminder to stop eating foods that can result in indeterminate diagnoses in the preferred embodiment of the invention
406. Reminder to arrange a pickup for the User in the preferred embodiment of the invention
407. Reminder to stop eating solid foods in the preferred embodiment of the invention
408. Reminder to perform an enema in the preferred embodiment of the invention
409. Reminder to go to the location of the upcoming medical procedure in the preferred embodiment of the invention
410. Reminder of the time on the date and time of the medical procedure in the preferred embodiment of the invention
411. Reminder to follow up with the physician after the medical procedure in the preferred embodiment of the invention
601. Interactive Selection Prompt for a set of Reminders and Sub-Reminders in an embodiment of the invention.
701. Selection prompt for editing the User information regarding the anticipated medical procedure in the preferred embodiment.
702. Display of the User's Current Input Information.
801. Frequently Asked Questions and corresponding answers to said Frequently Asked Questions in an embodiment of the invention.
901. Visual Aids related to the Medical Procedure in an embodiment of the invention.
1001. Audio Presentation of Text, Audio, and/or Visual Display embodiment
1002. Prompt to Continue embodiment
1003. Interactive Selection Prompt Example A embodiment
1004. Text, Audio, and/or Visual Display Example A embodiment
1005. Text-Based Aids embodiment

### DETAILED DESCRIPTION

The present invention enables a method for preparing a patient for a medical procedure, said method comprising a software-related application executed on a computer device. Specifically, embodiments of the present invention provide a method for instructionally reminding a User for steps involved in a colonoscopy preparation process. More specifically, a method is provided for multimedia instructional reminders to a user on a mobile communication device, wherein preferred types of multimedia communication can be selected.

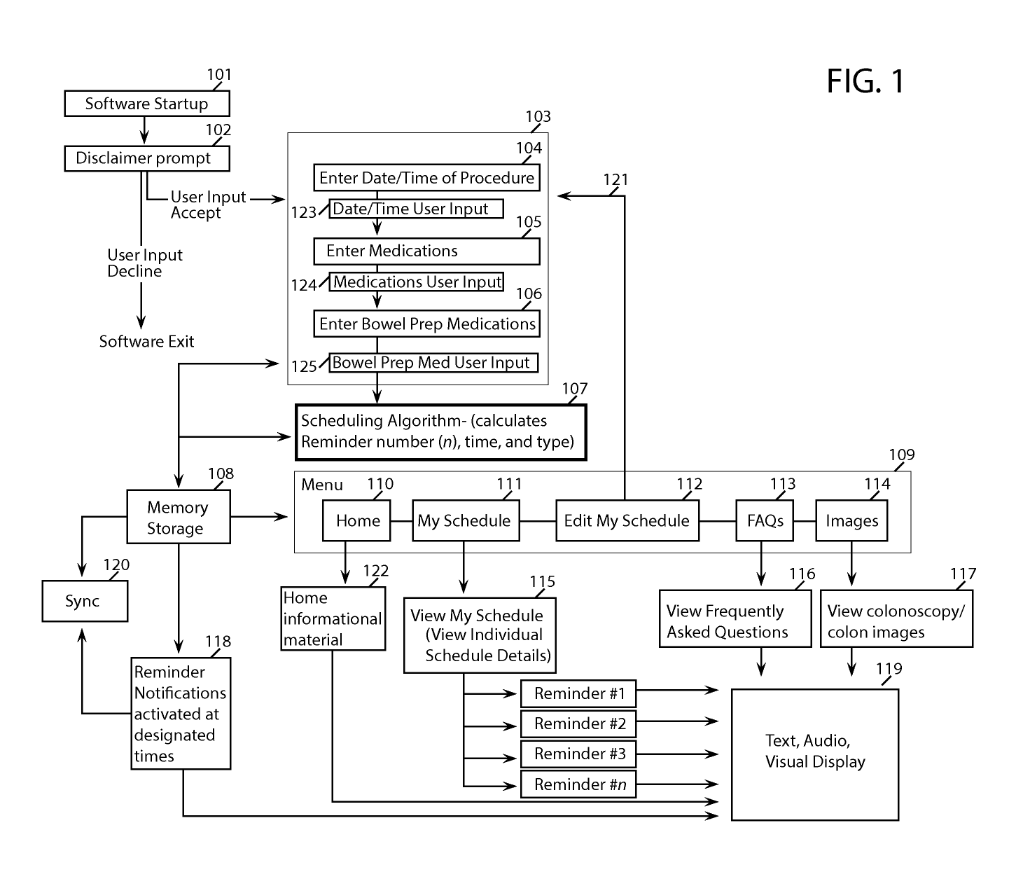

A flow chart for preparing a patient for a medical procedure, using the application software in the preferred embodiment of the invention is illustrated in FIG. 1. The following describes an embodiment of the invention to aid a User for the preparation for a colonoscopy using said software-related application on a mobile communication device. The software-related application, as disclosed herein, will be referred to as the “Medical Instruction App,” and interchangeably as “Colonoscopy Helper.” However, the Medical Instruction App is not limited to an application for a colonoscopy, and other embodiments of the invention are designed for other types of medical procedures. The User or plurality of Users of said software-related application, or the recipient of the medical procedure related to the Medical Instruction App, which in general comprises patients receiving the medical procedure, will be herein referred as the “User.”

The preferred embodiment of the Medical Instruction App is a software-related invention, executed on a processor-based computing device that increases the success and outcome of a Medical Procedure, such as a colonoscopy. The preferred embodiment of the Medical Instruction App is downloadable and installable. The preferred embodiment of the Medical Instruction App is not limited to a specific hardware platform or operating system. In the preferred embodiment of the invention, the Medical Instruction App is utilized on a mobile processor-based device, such as for example, commonly known in the prior art as a “smart phone” or “tablet.”

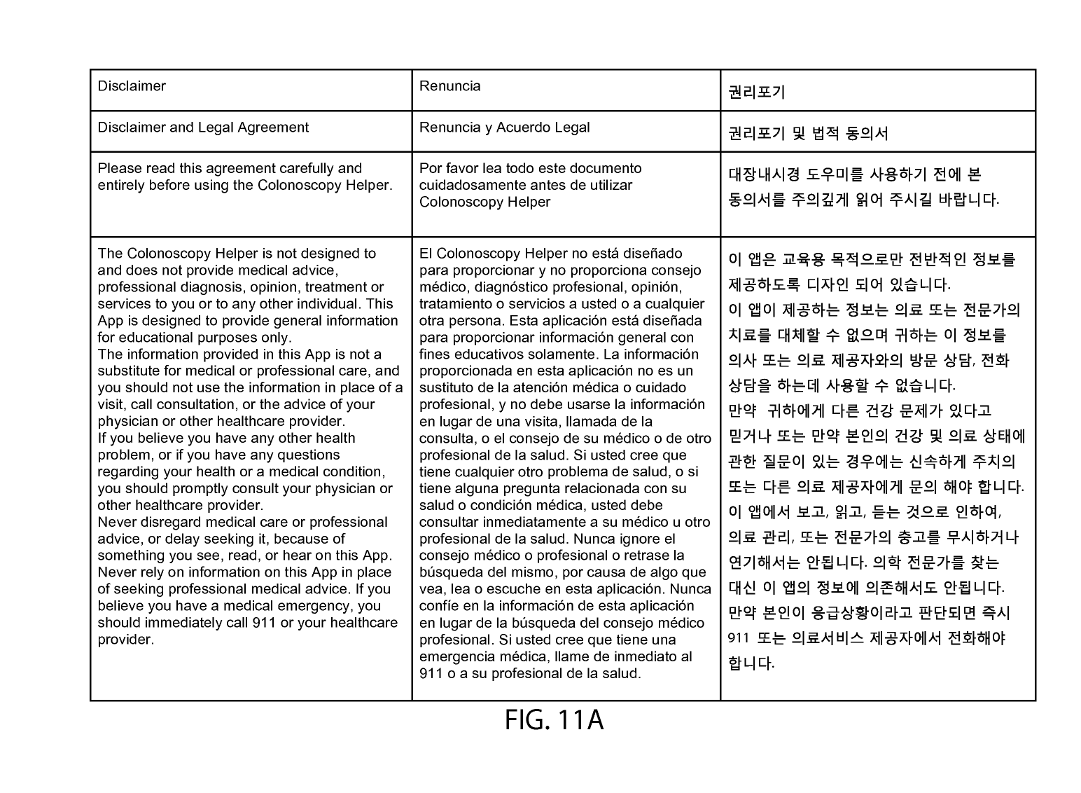

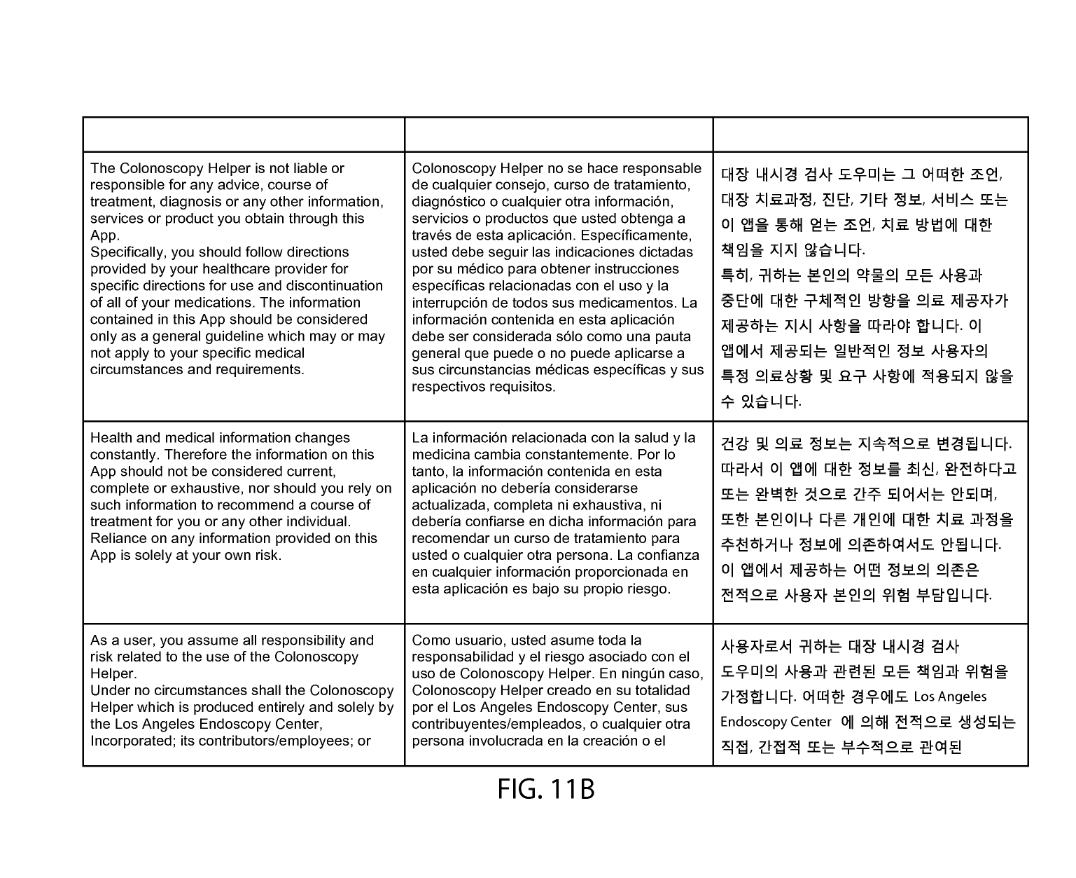

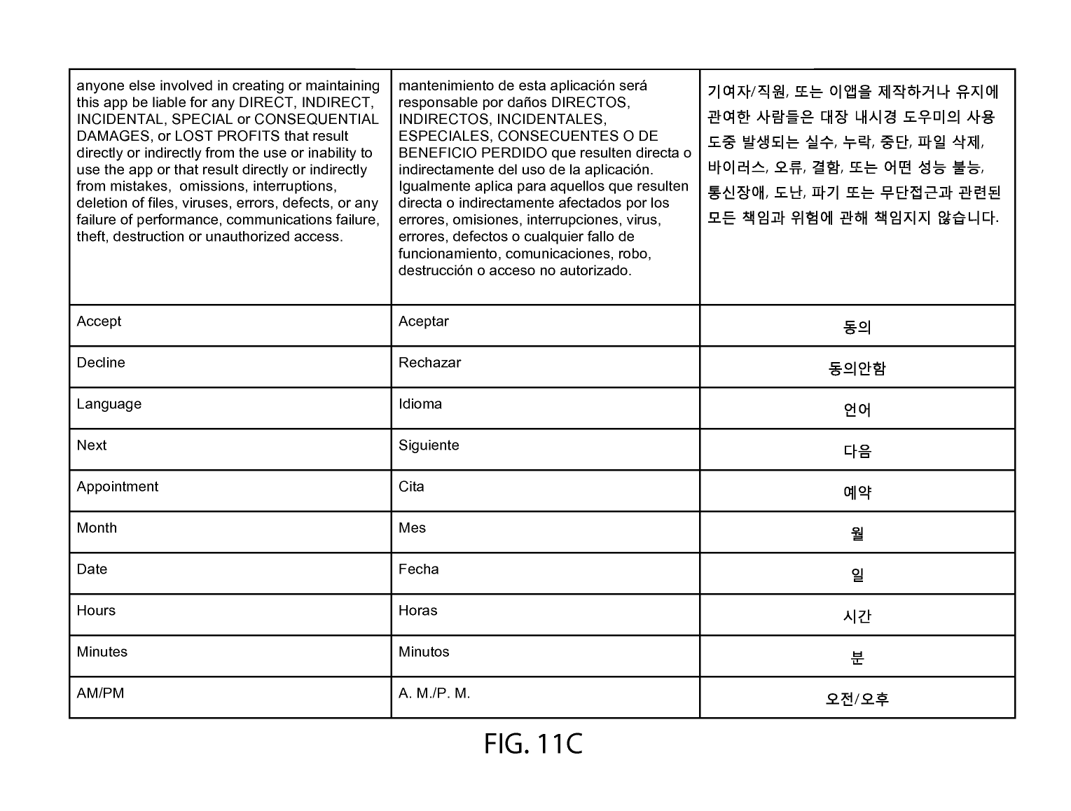

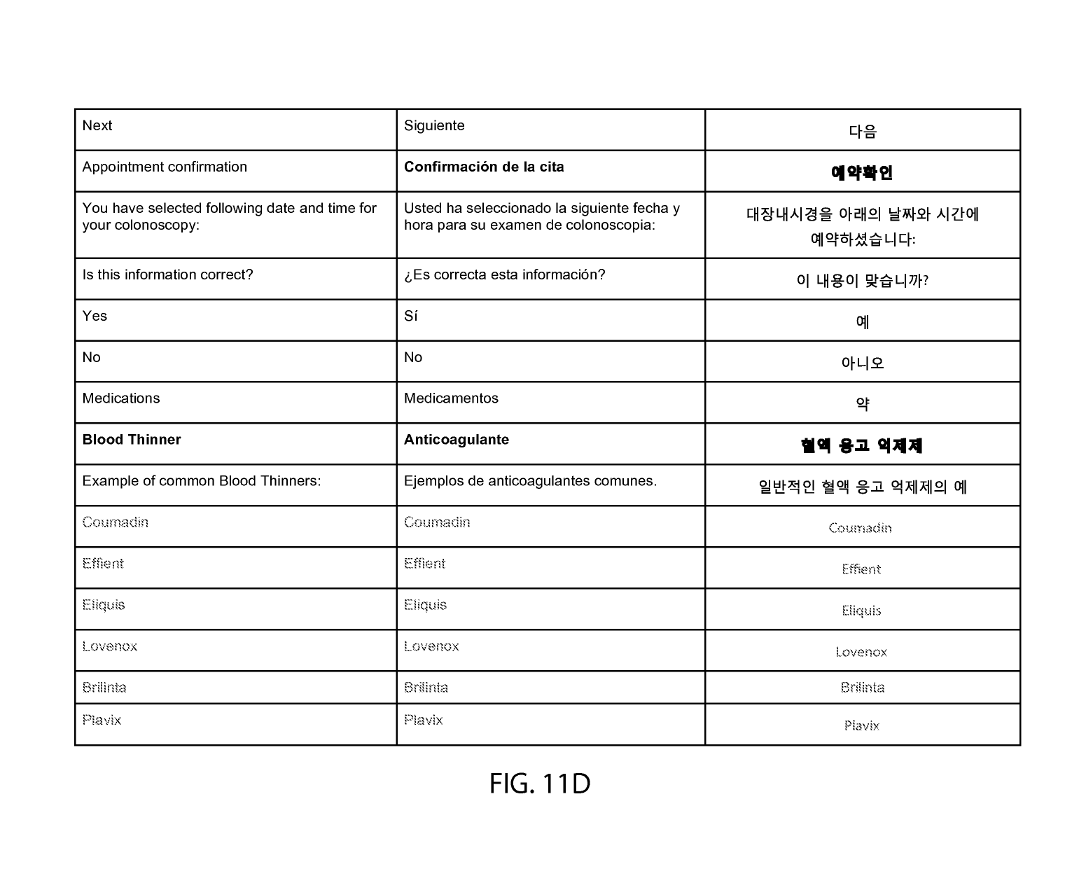

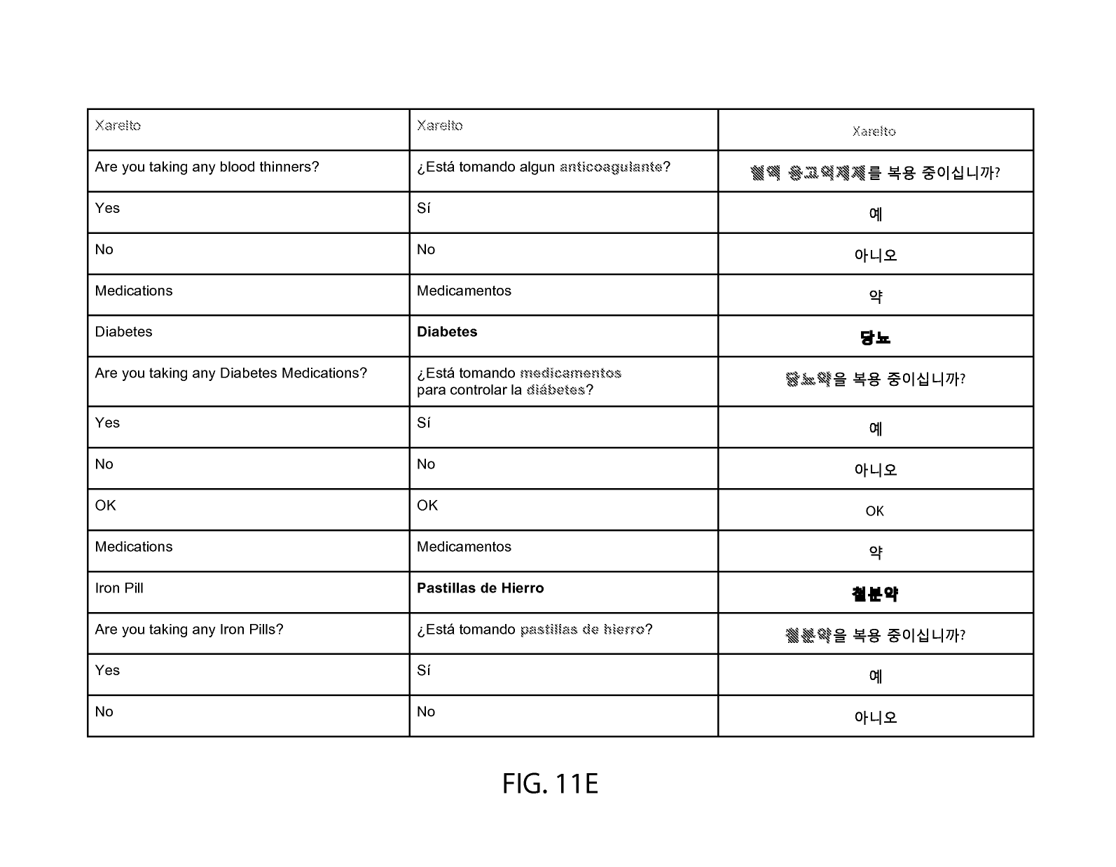

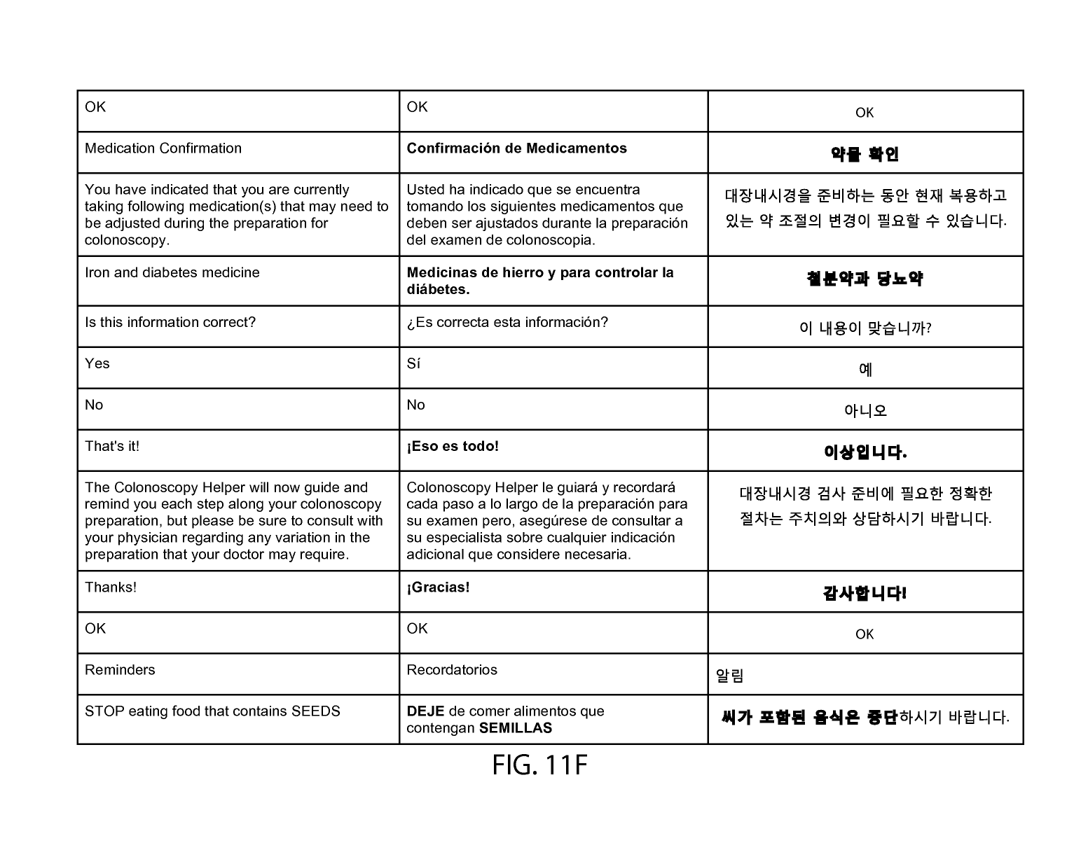

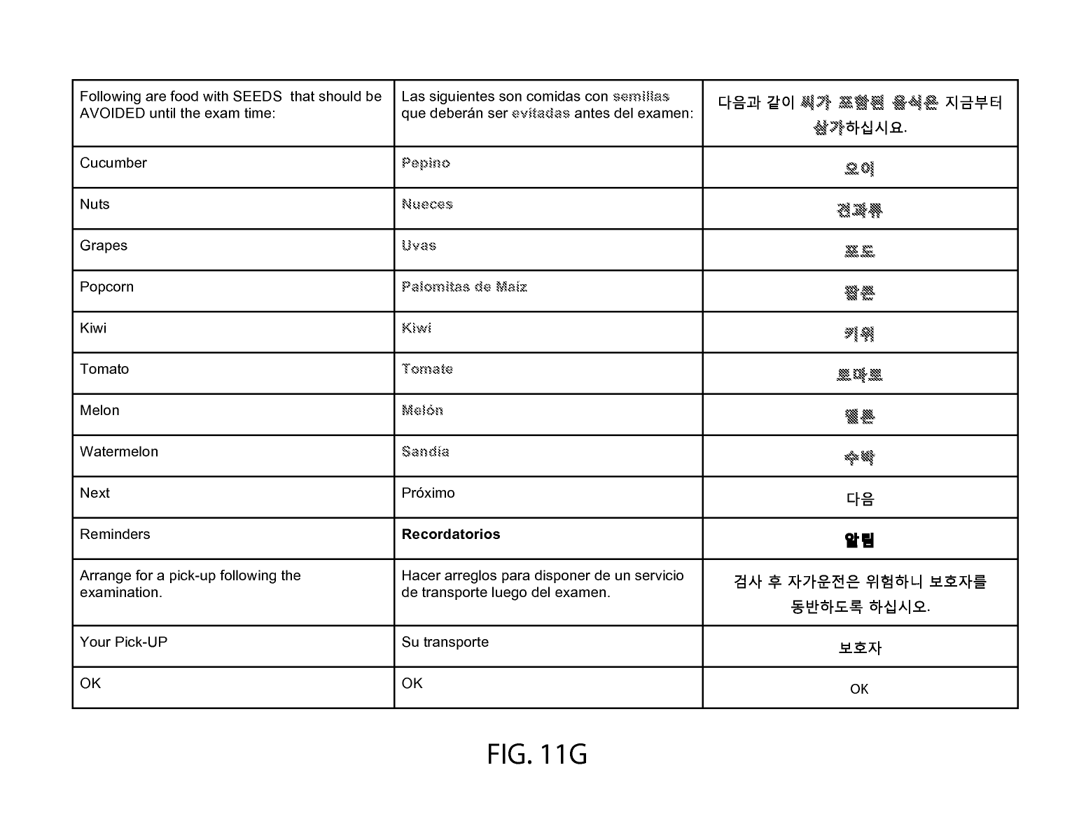

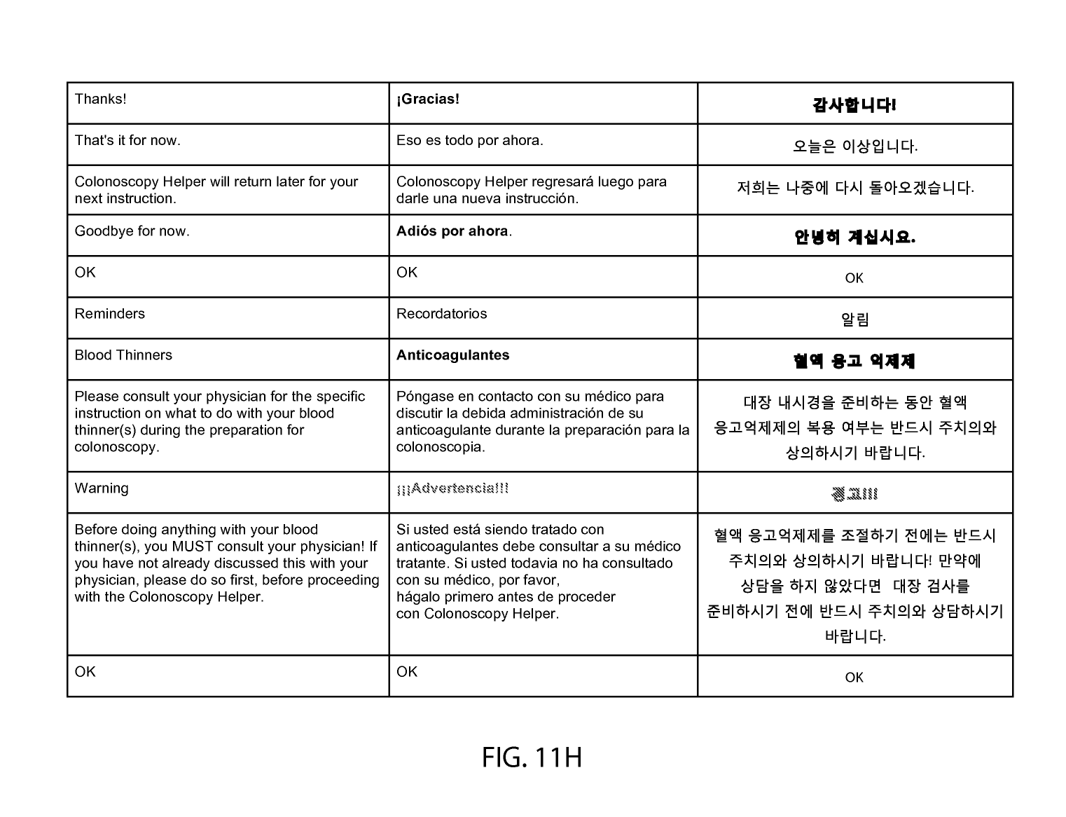

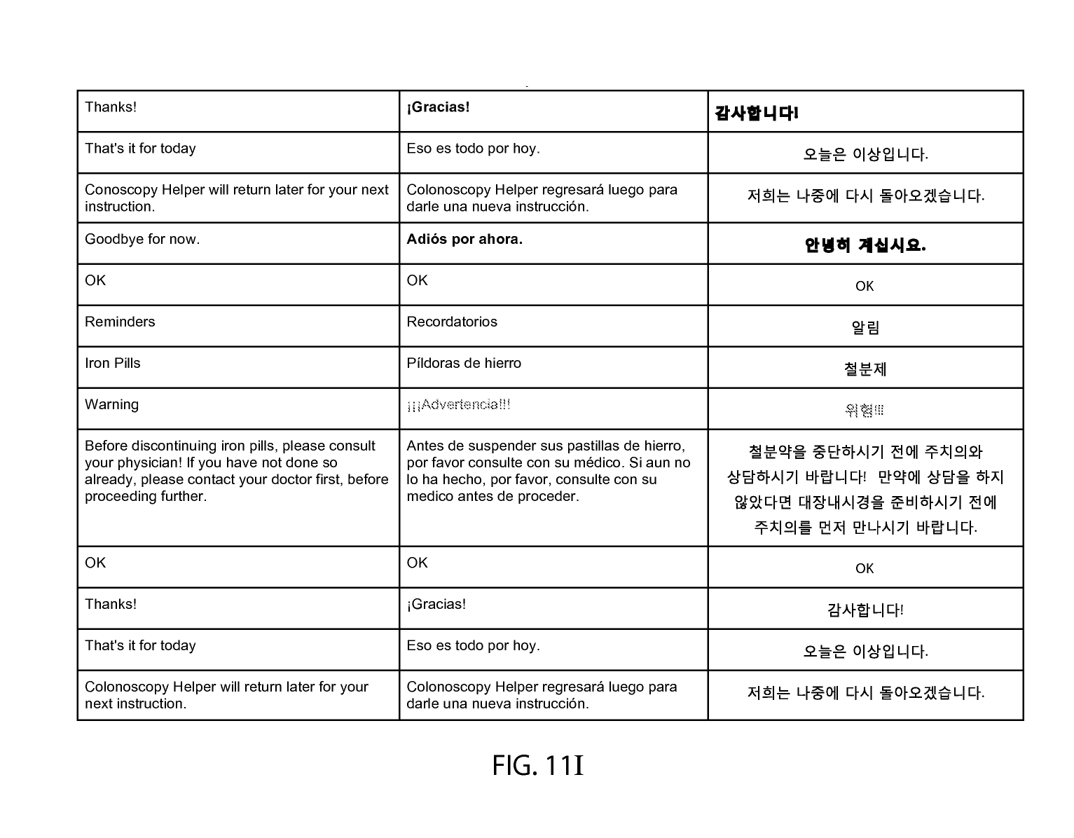

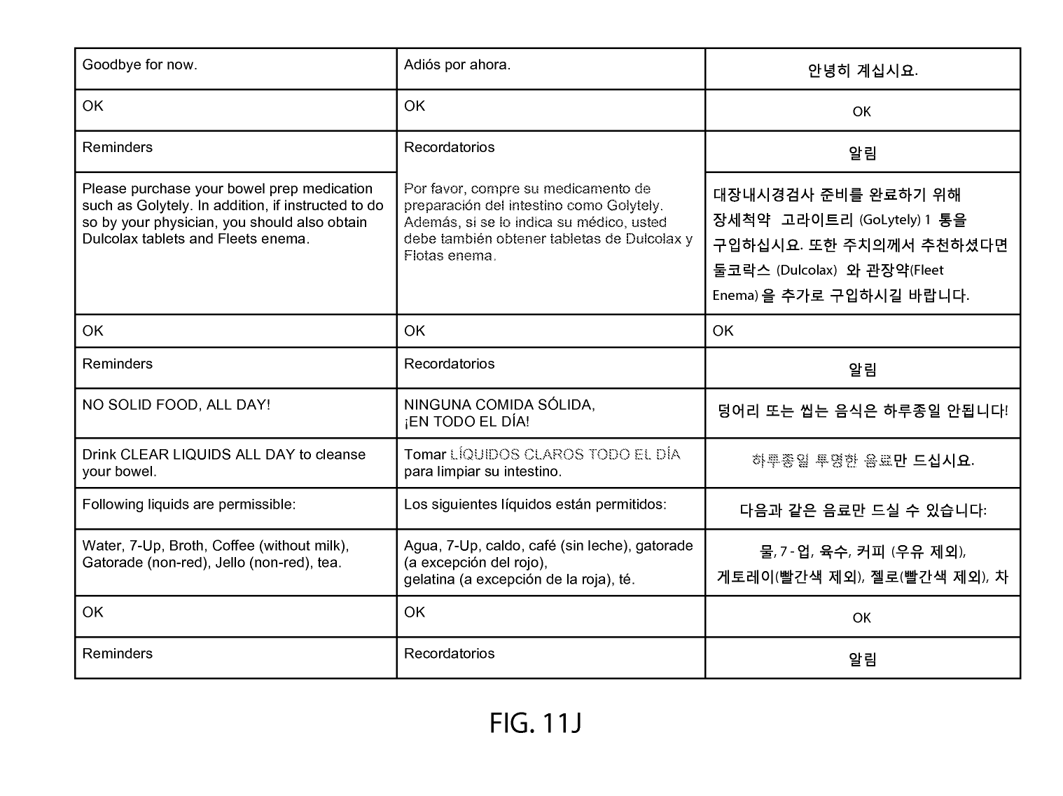

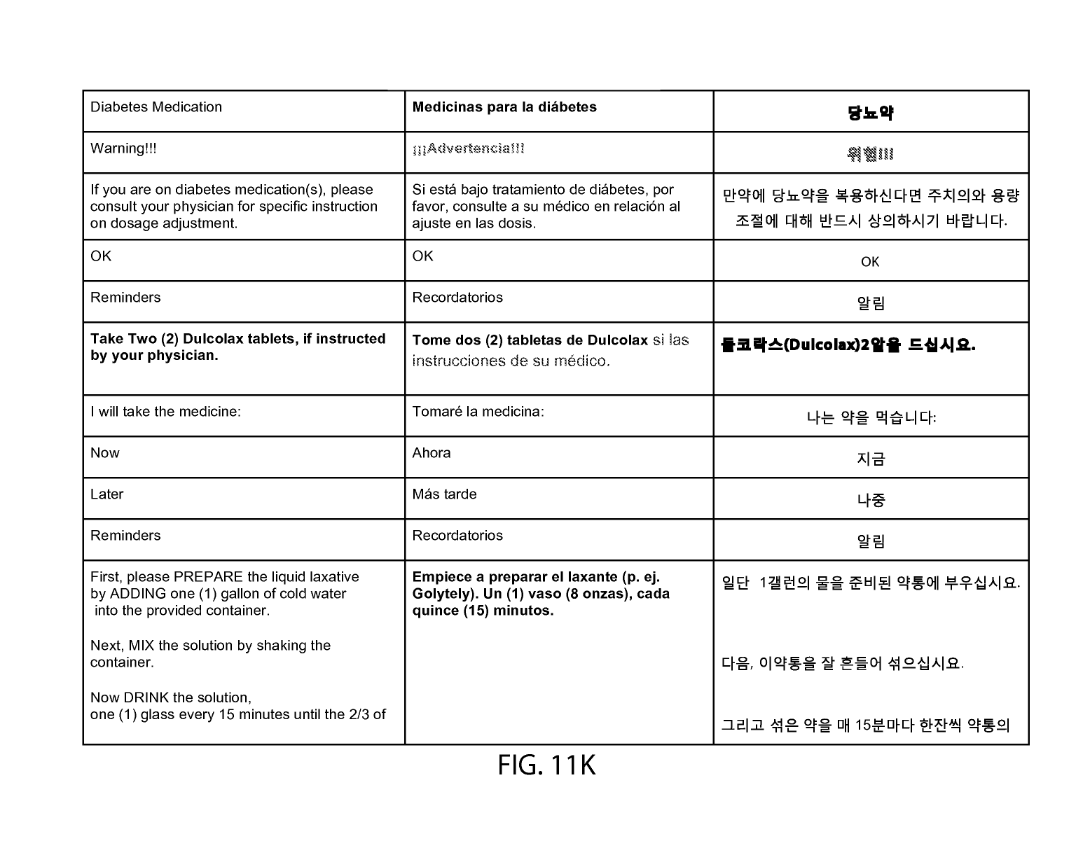

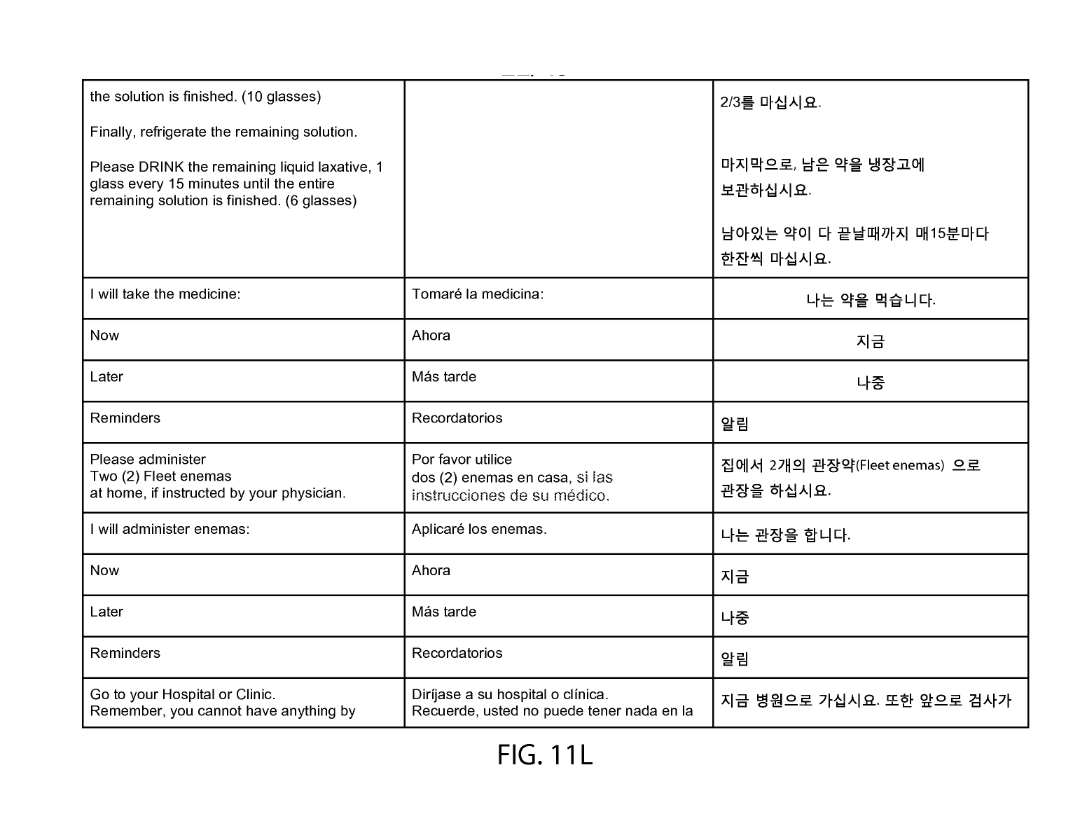

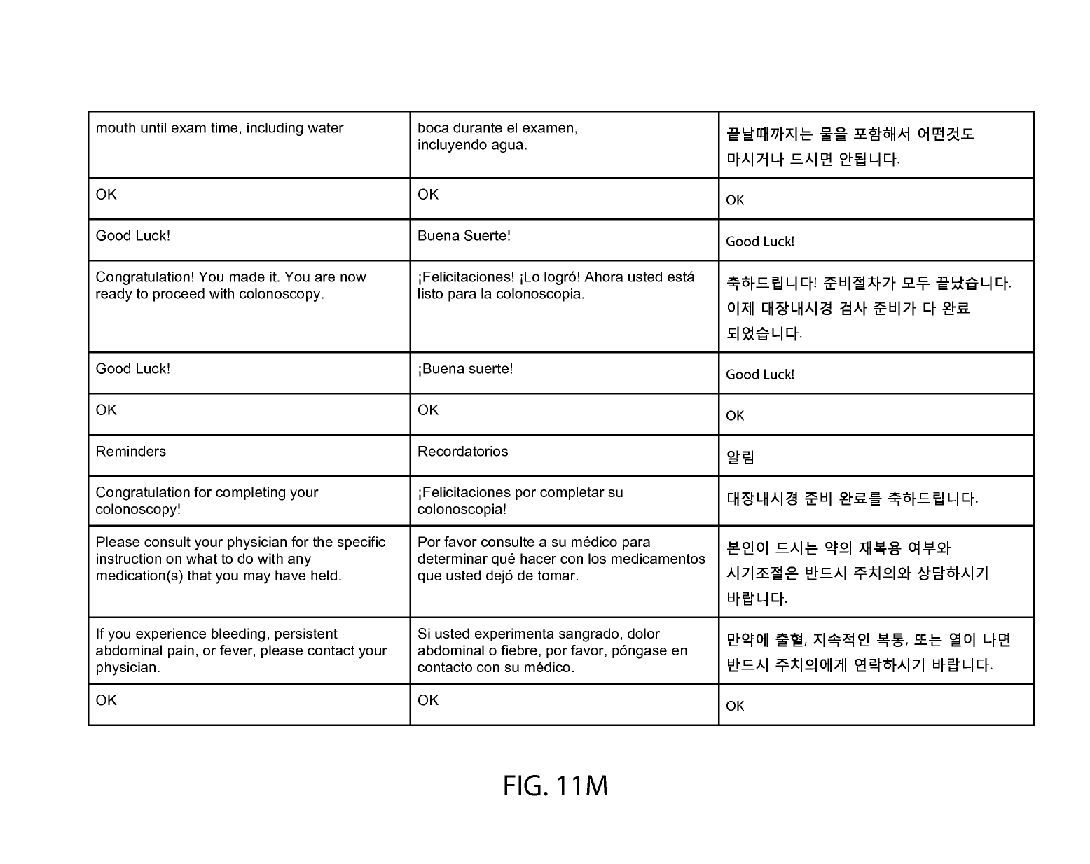

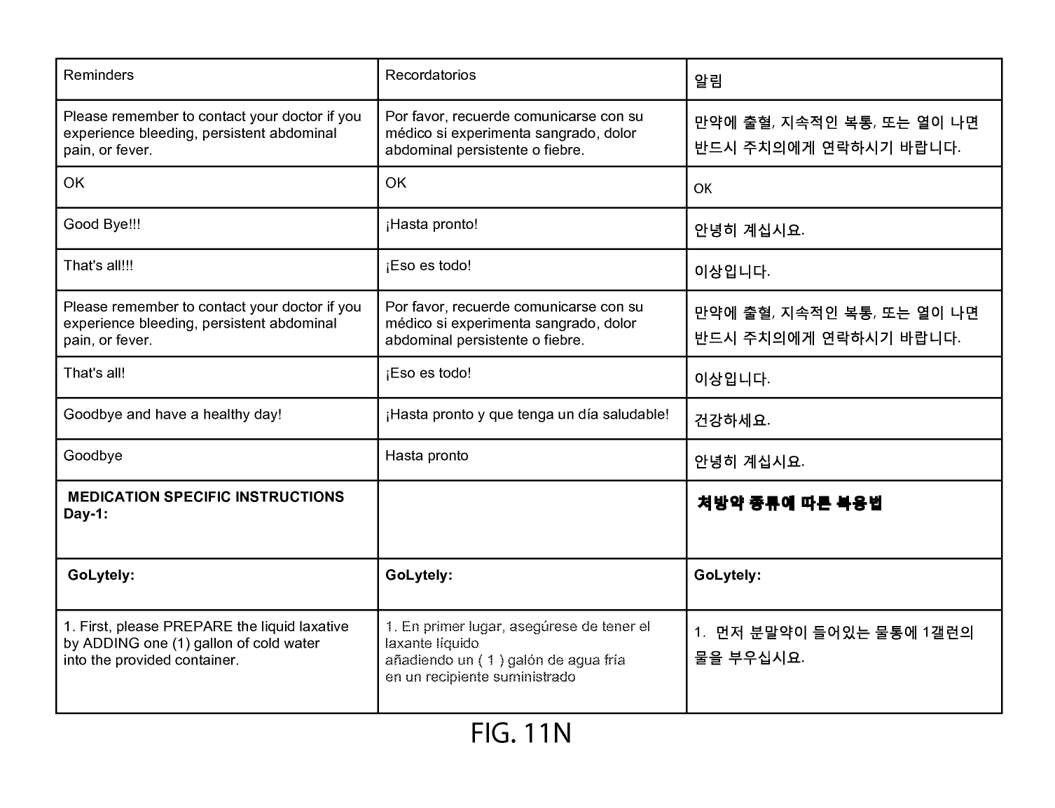

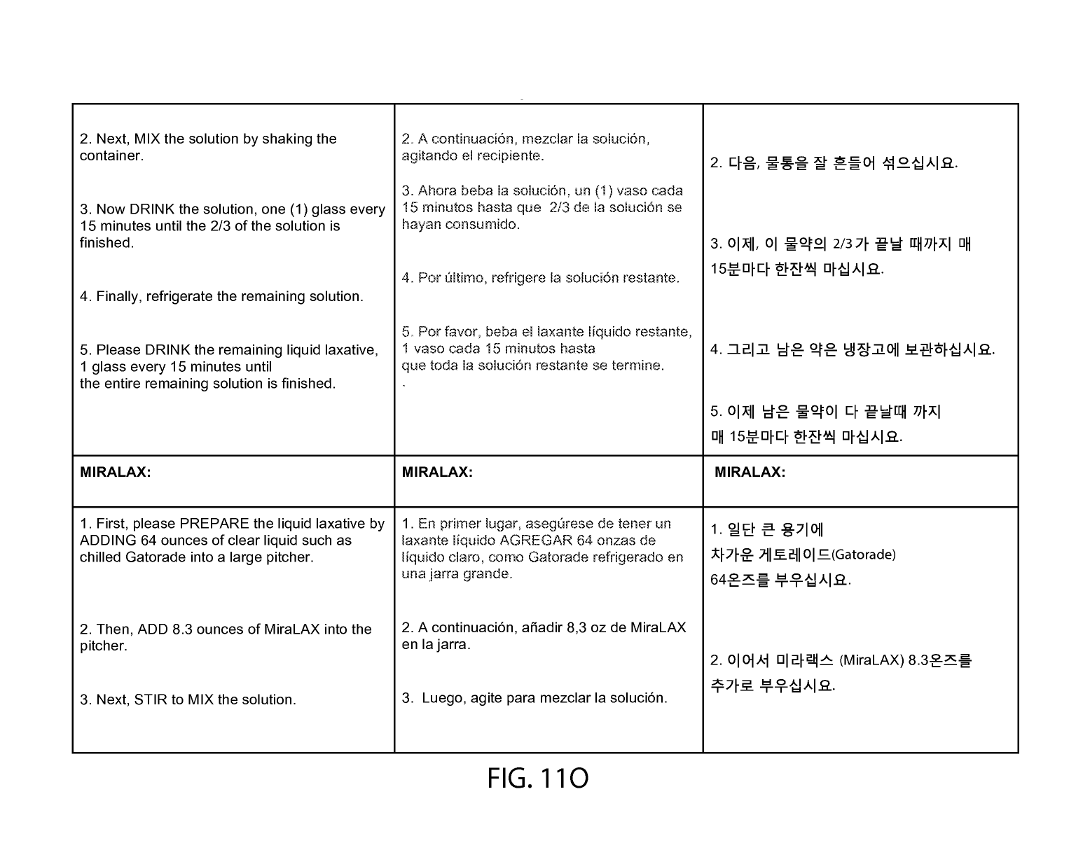

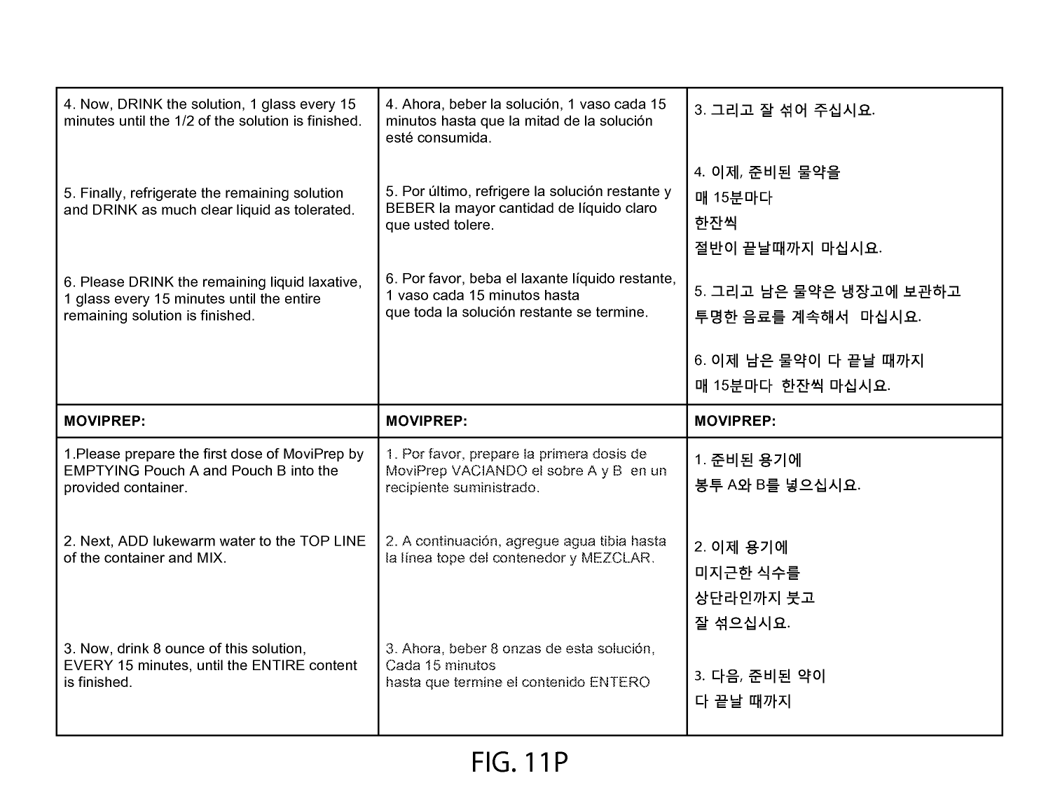

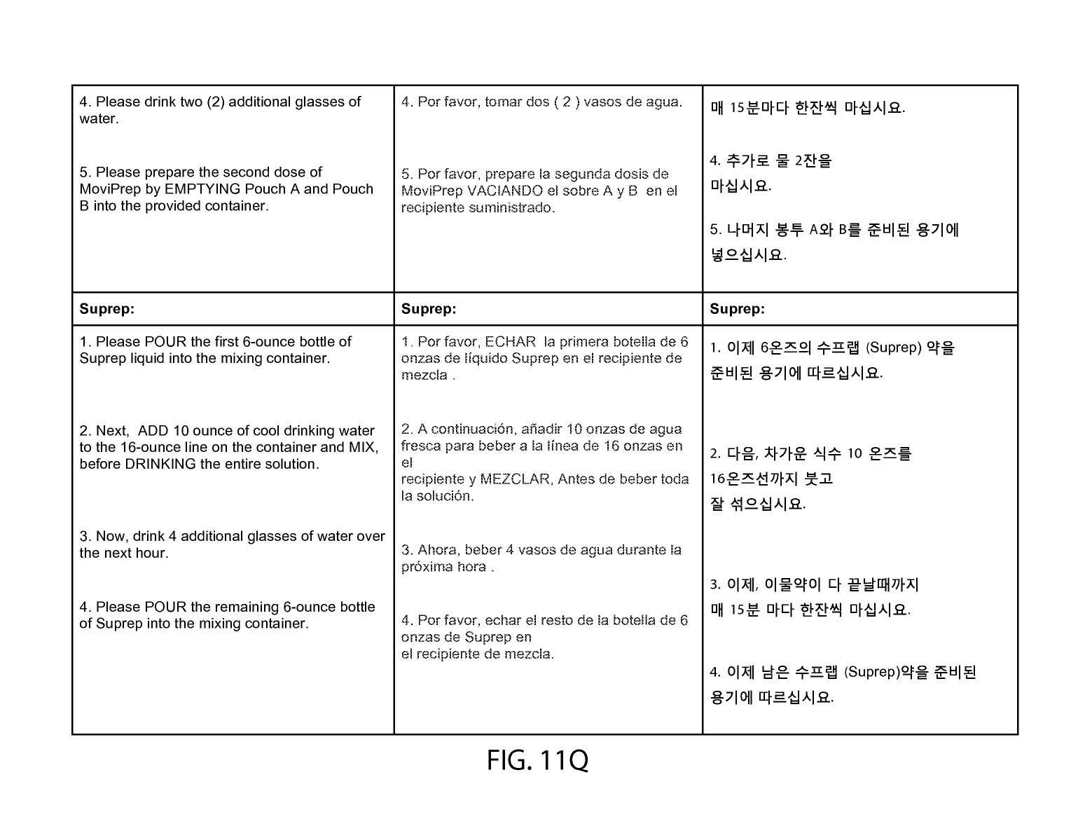

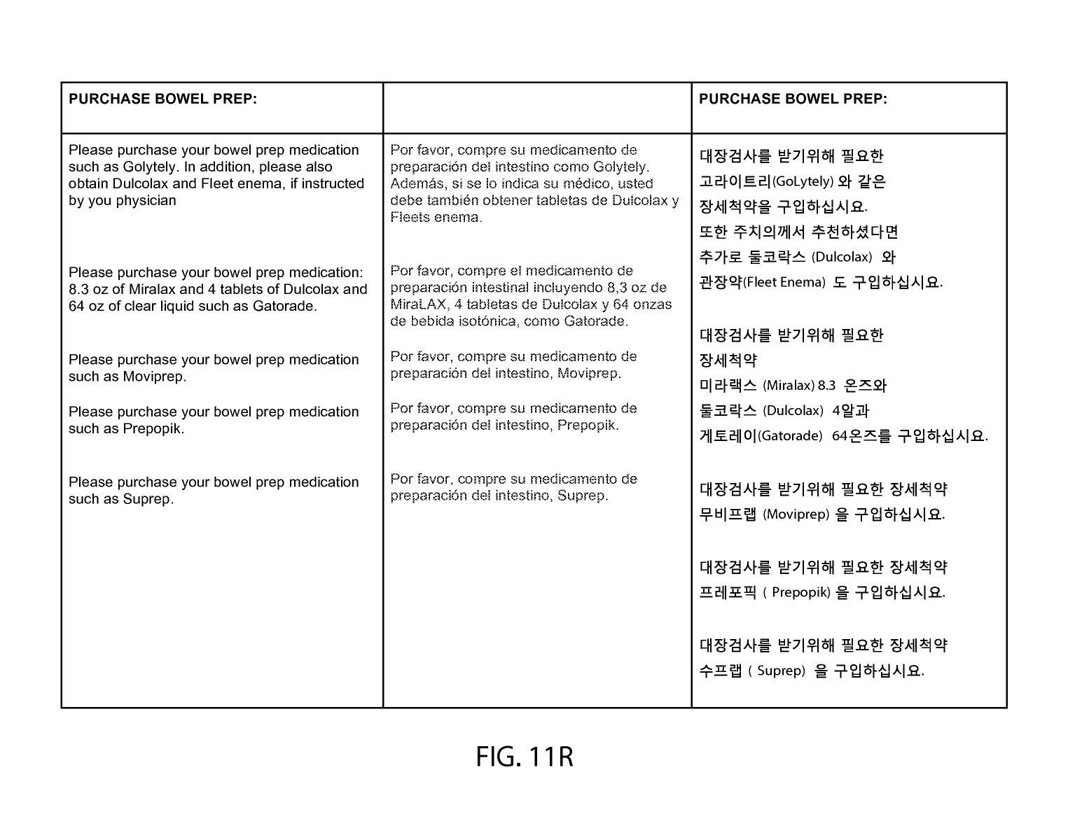

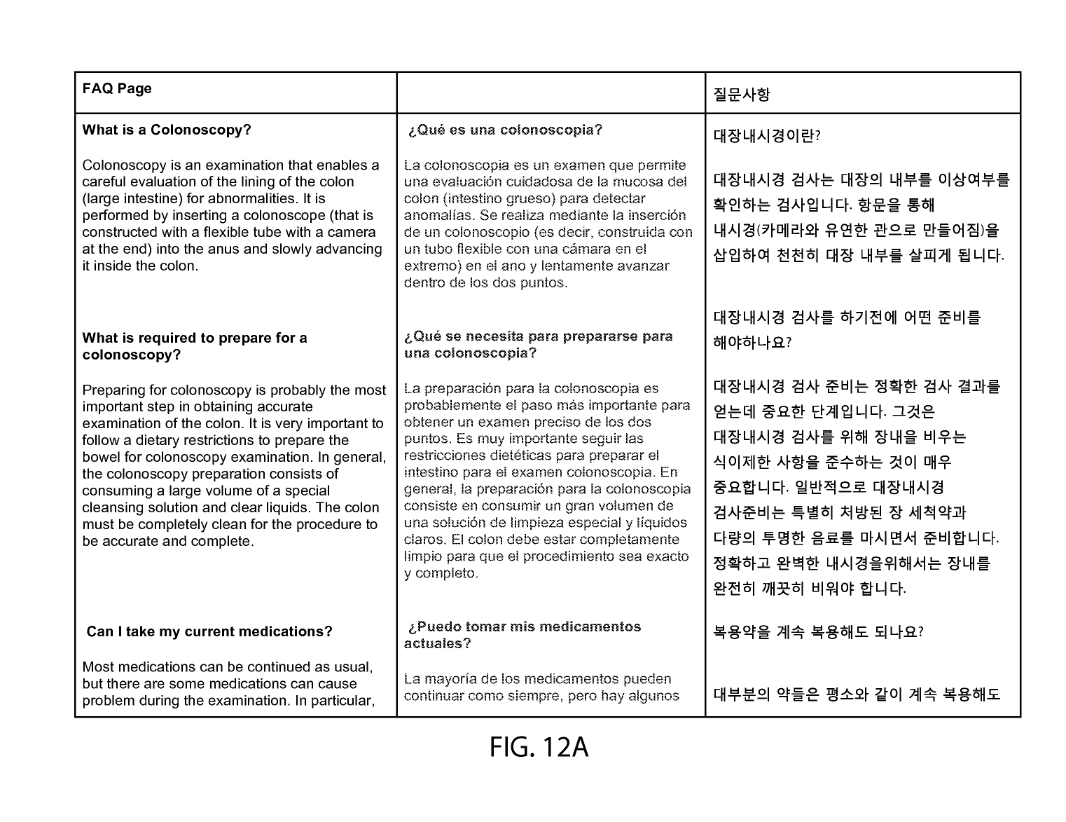

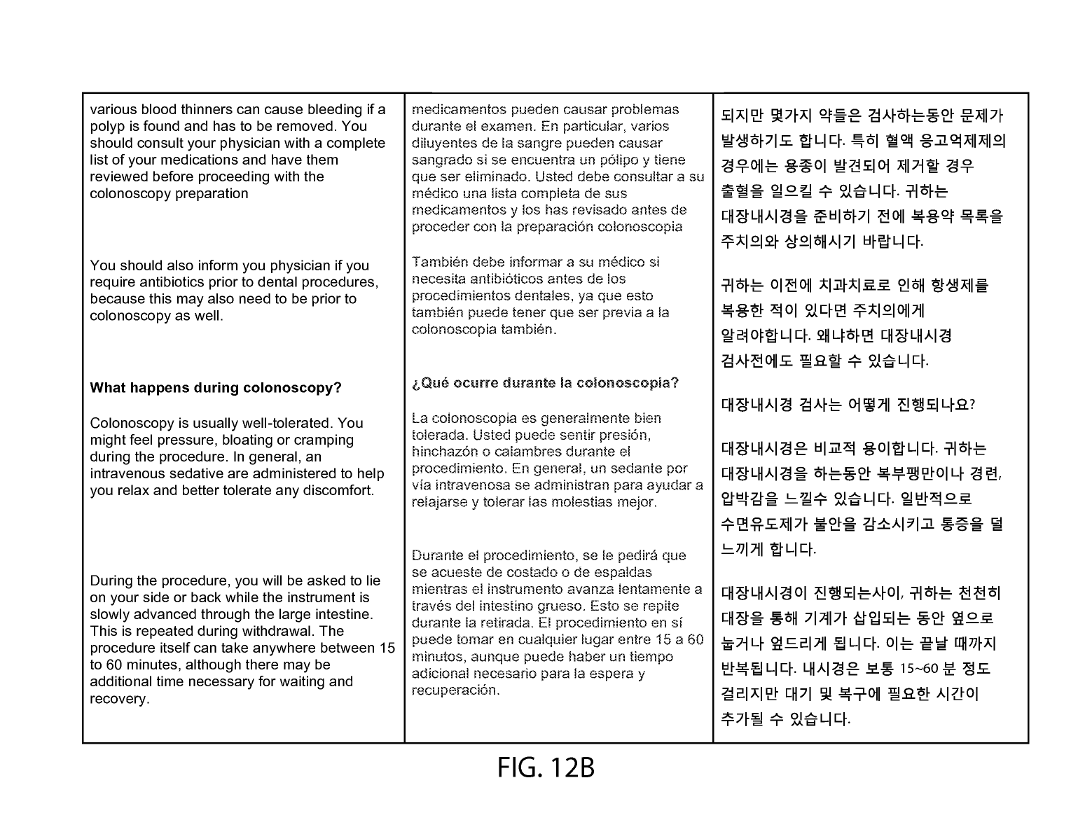

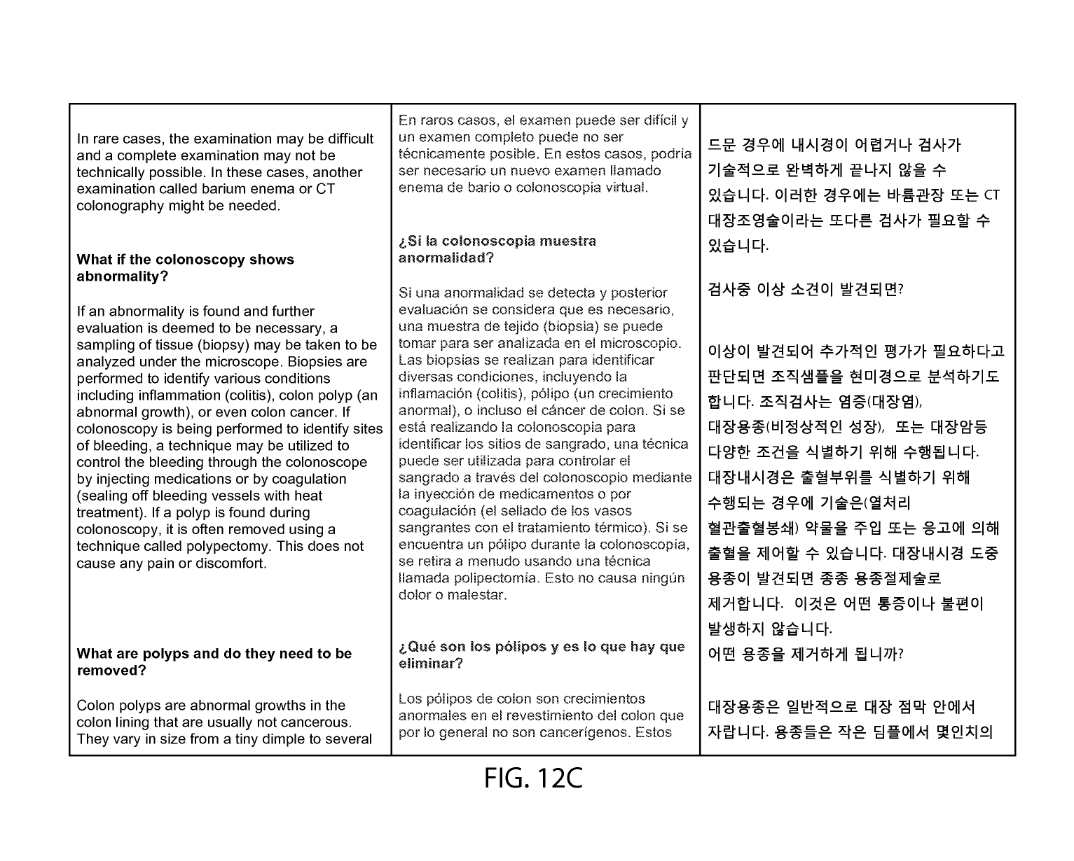

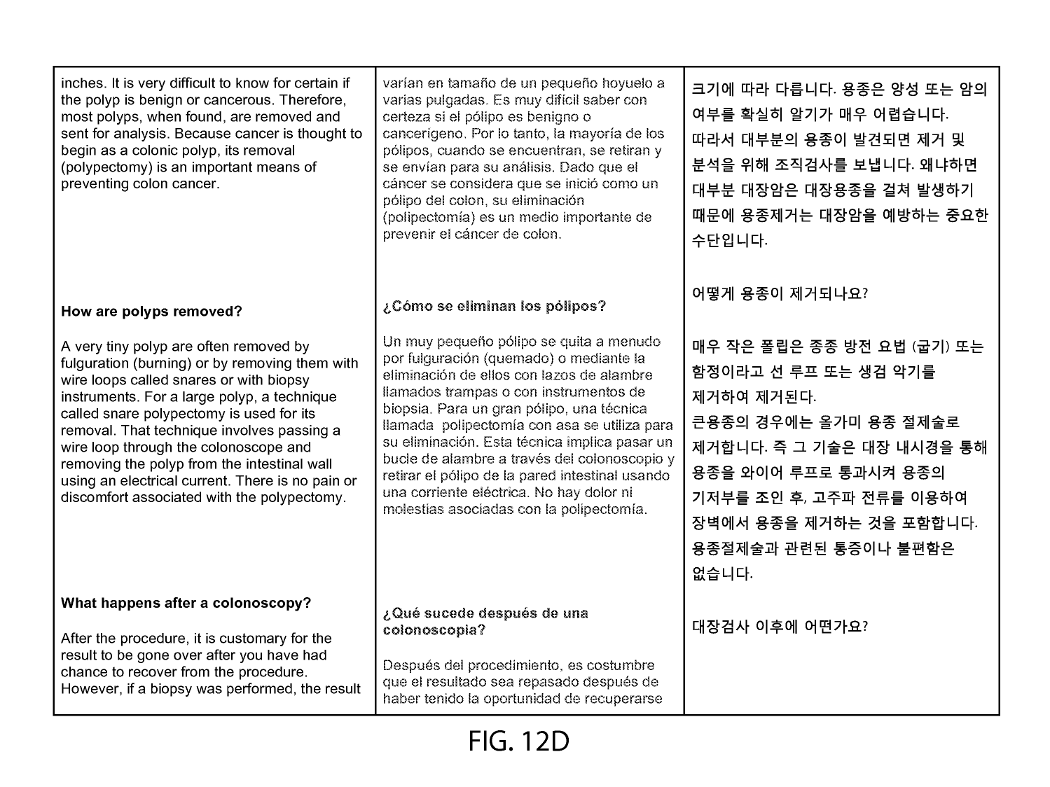

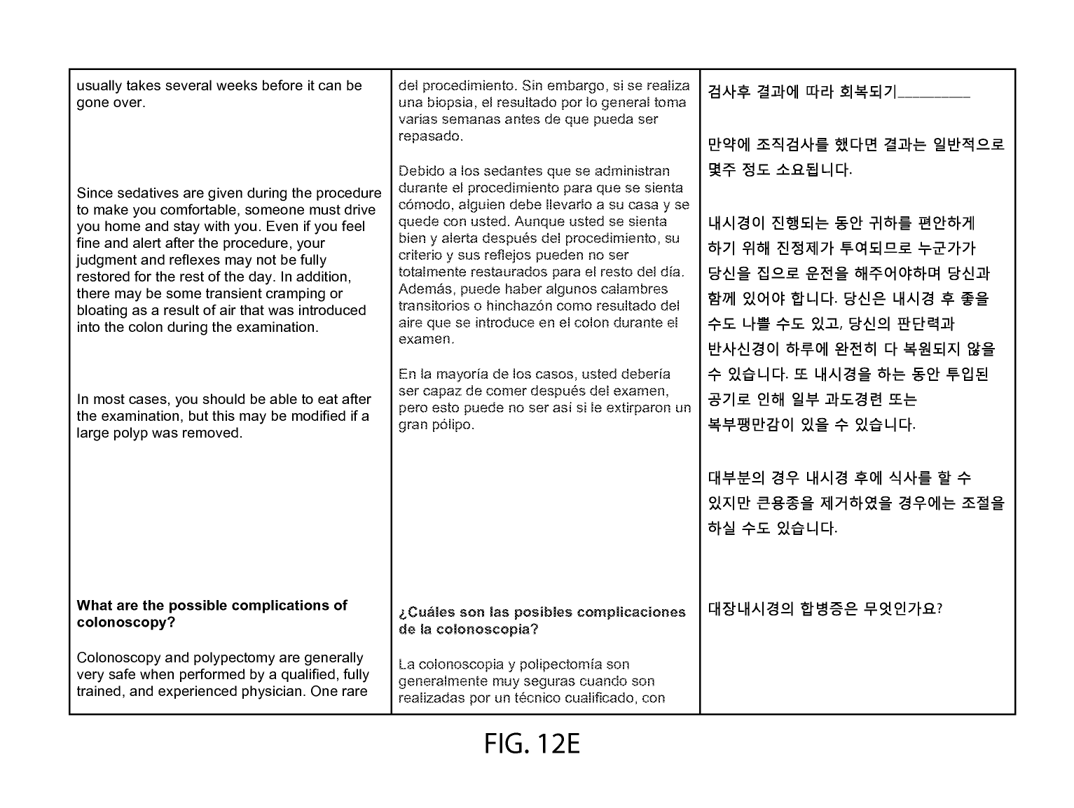

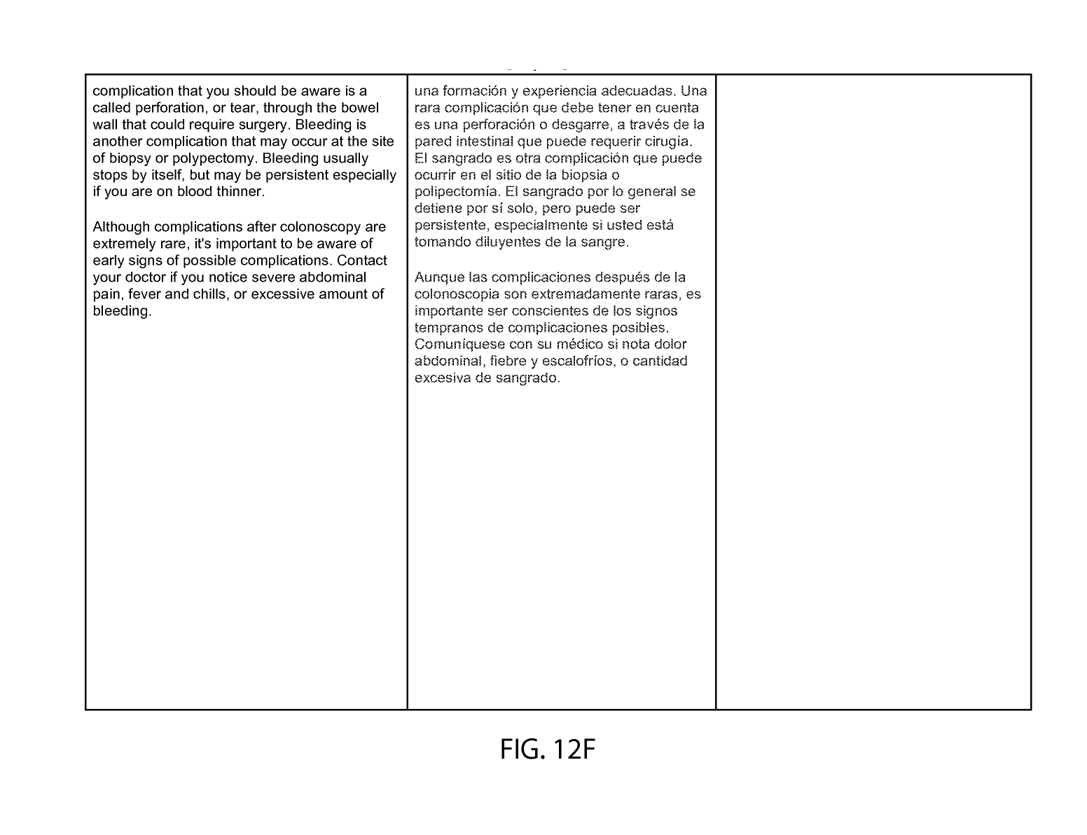

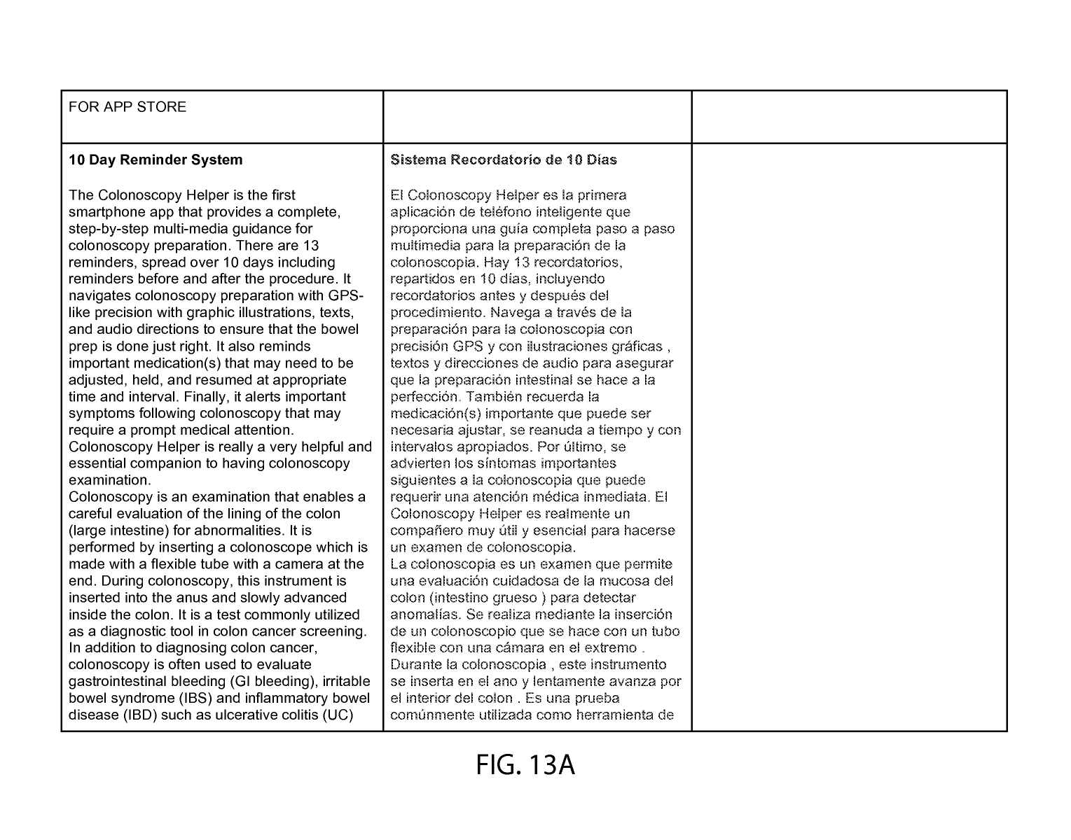

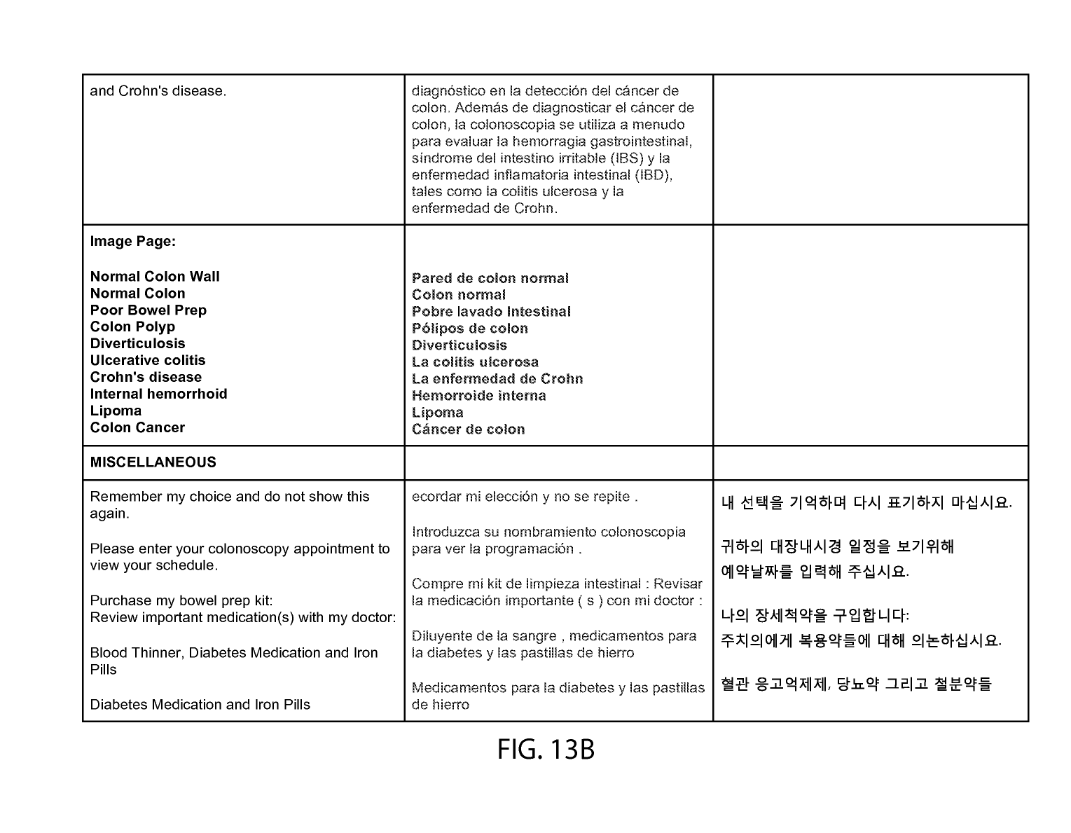

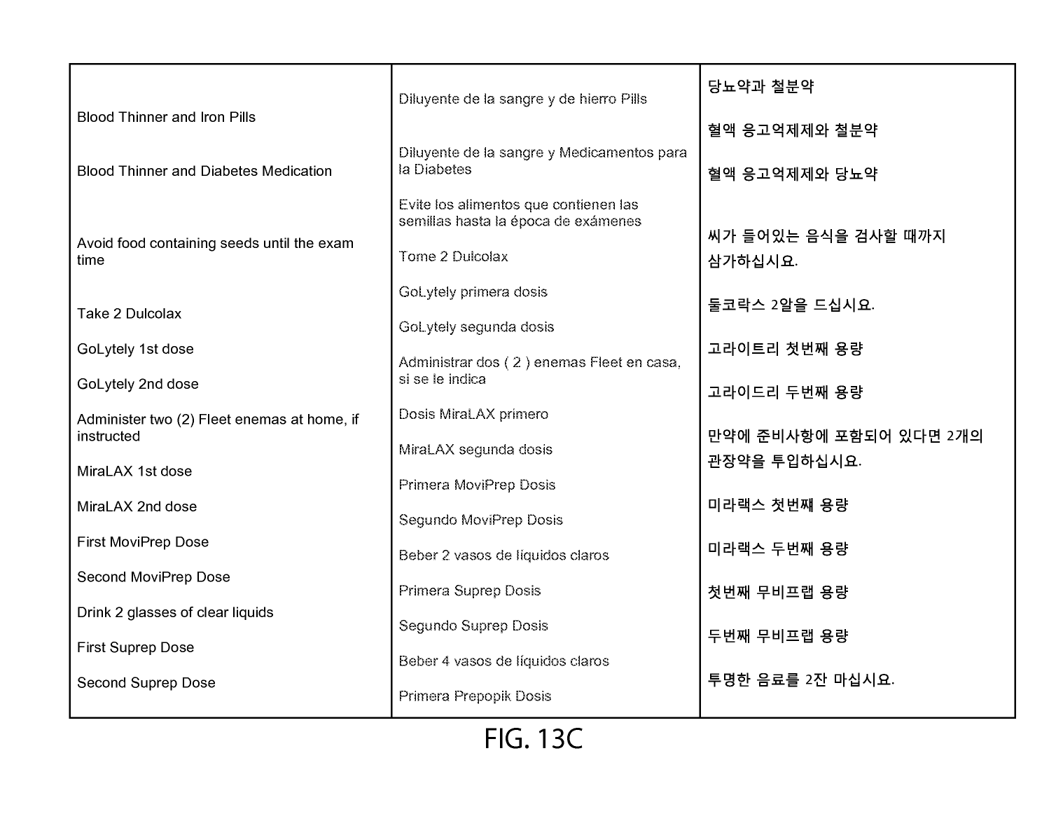

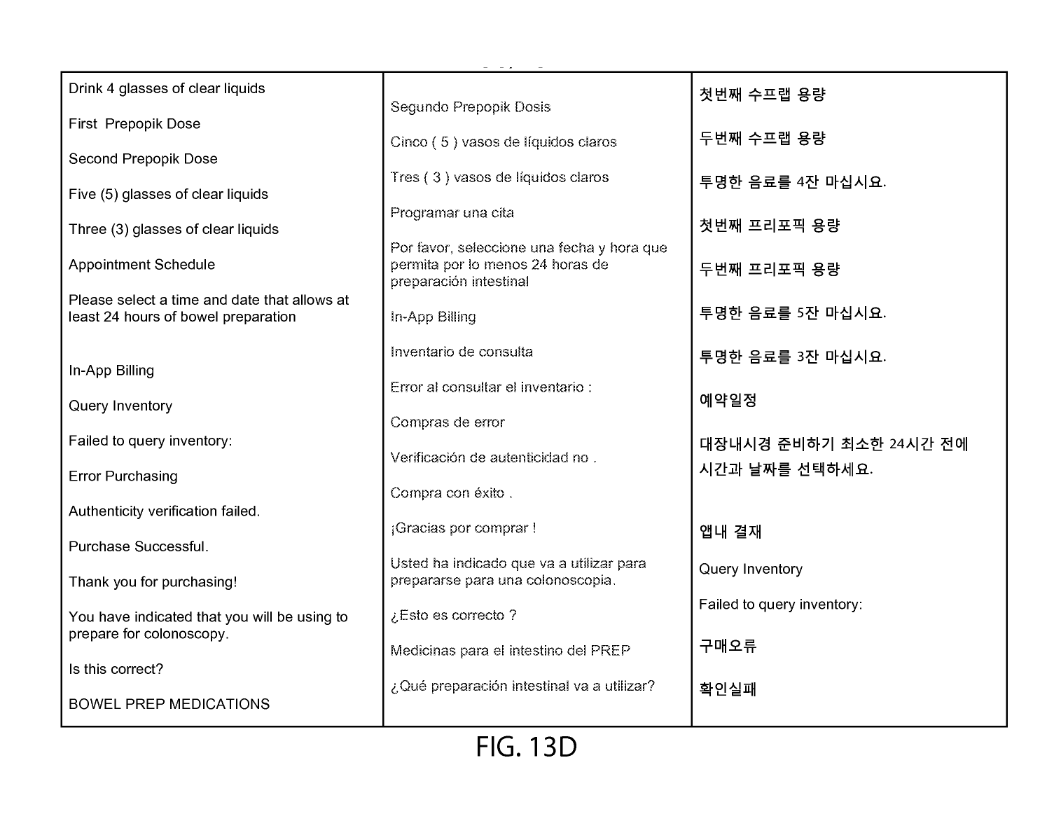

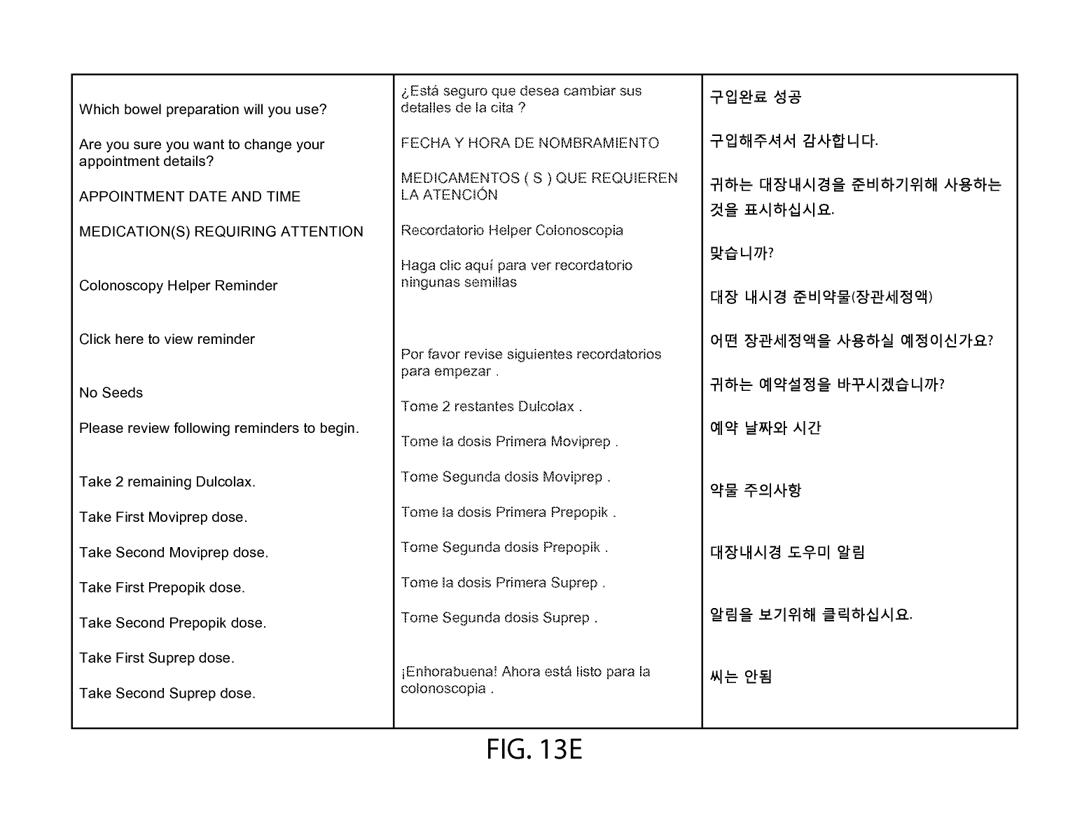

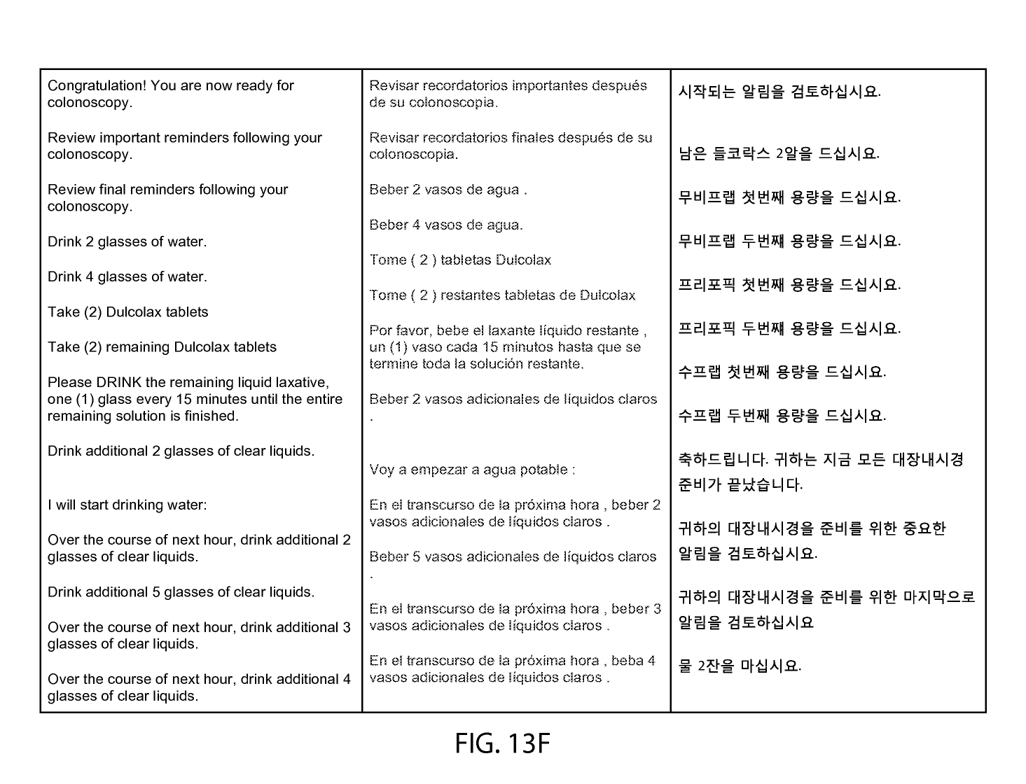

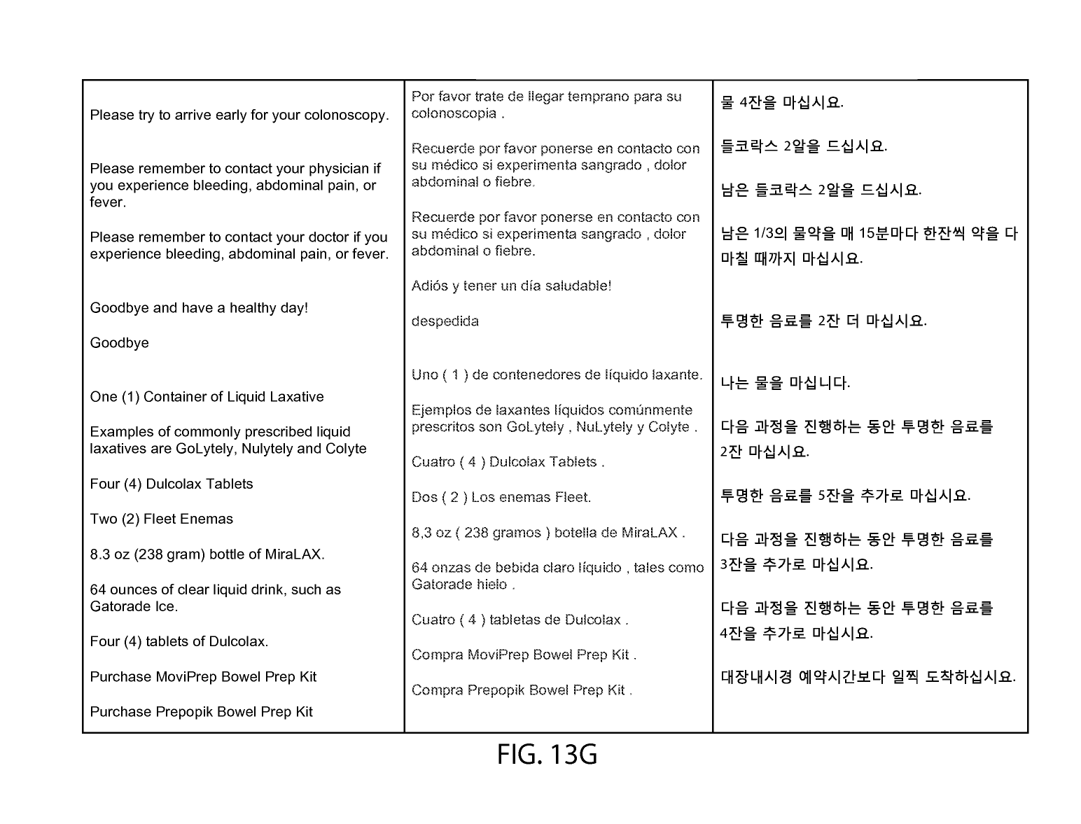

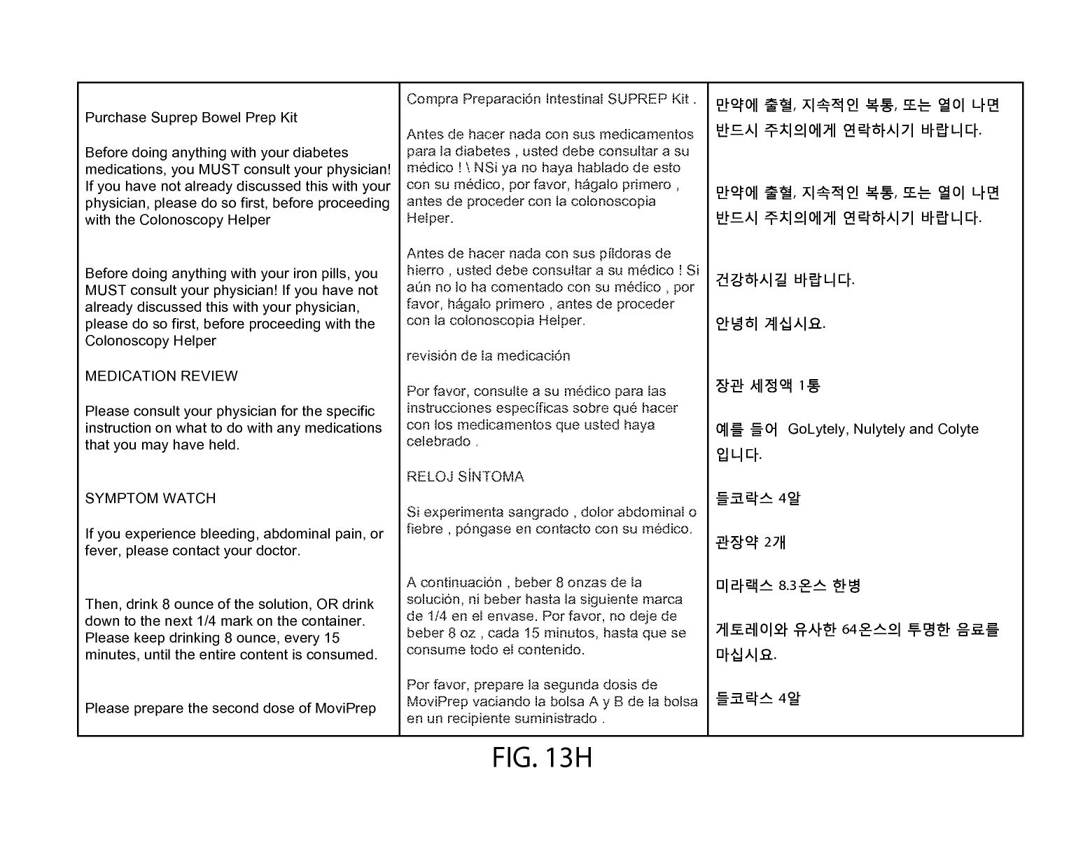

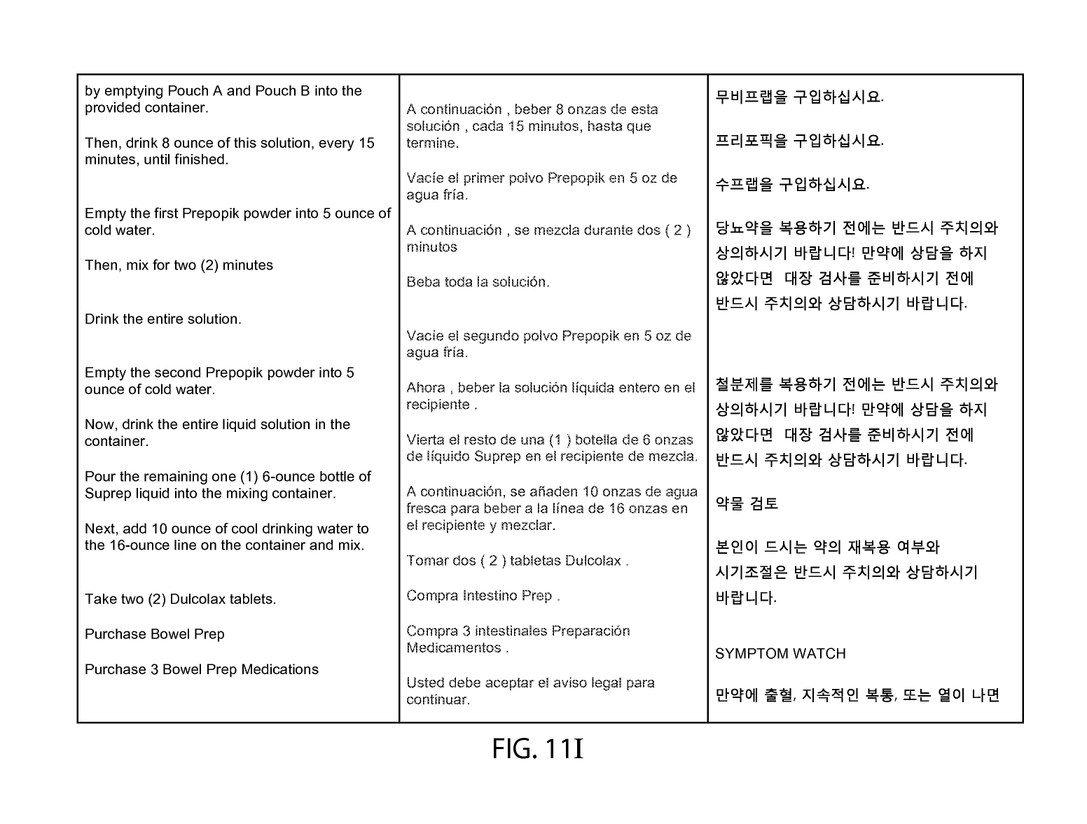

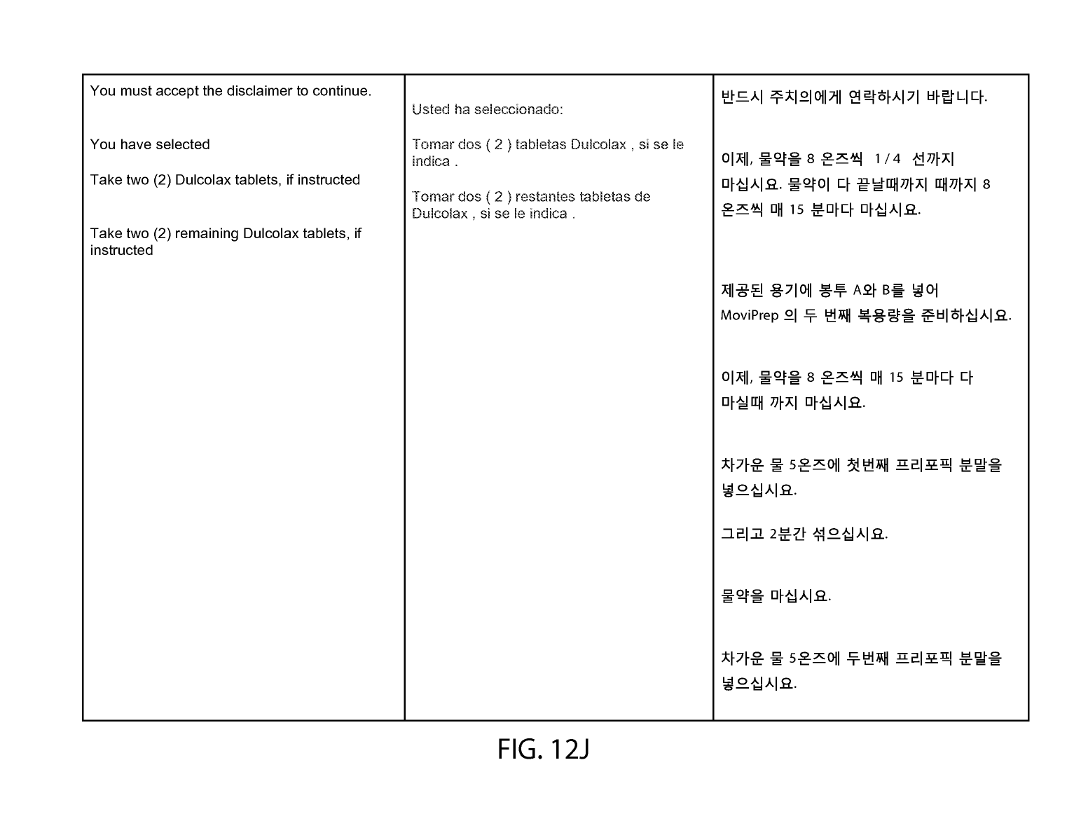

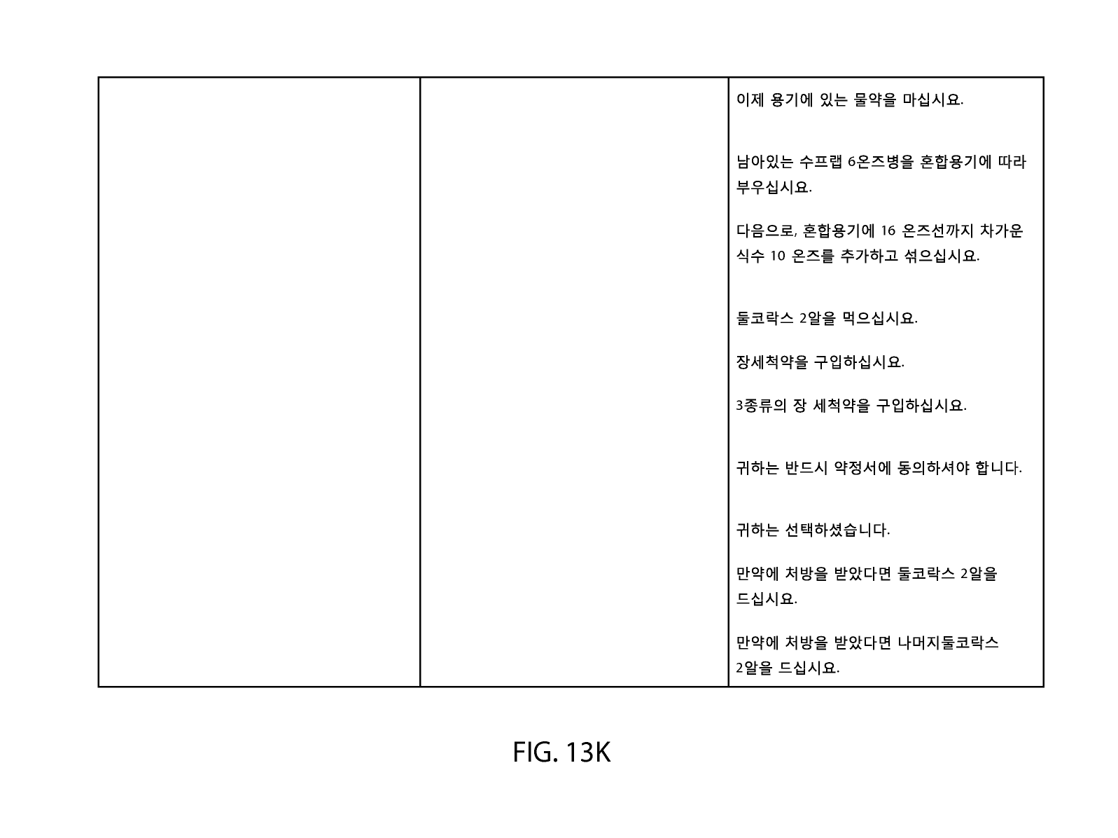

The preferred embodiment of the Medical Instruction App comprises an option to select a language, wherein said language selection option enables a User to utilize the Medical Instruction App with a preferred language, said language including, but not limited to, English, Spanish, and Korean. The language selection option enables Users of various language backgrounds to effectively utilize the Medical Instruction App. In one embodiment of the invention, the language of the Medical Instruction App is selected prior to the User downloading and installing the Medical Instruction App. In other embodiments of the invention, the language selection option is prompted at startup of the Medical Instruction App, wherein a User may select the preferred language that is displayed within the software application. Examples of the text utilized in the Medical Instruction App translated in English, Spanish, and Korean, in the preferred embodiment of the invention, are shown in FIG. 11A through FIG. 11R, FIG. 12A through FIG. 12F, and FIG. 13A through FIG. 13K

In the preferred embodiment of the invention, the process for the Medical Instruction App initiates, in general, by execution 101 of the Medical Instruction App. Following execution 101 of the Medical Instruction App, the preferred embodiment of the invention outputs a disclaimer requesting 102 User input. Said disclaimer comprises a medical information disclaimer and legal agreement. In one embodiment of the invention, the disclaimer comprises the following message:
“The Colonoscopy Helper is not designed to and does not provide medical advice, professional diagnosis, opinion, treatment or services to you or to any other individual. This App is designed to provide general information for educational purposes only. The information provided in this App is not a substitute for medical or professional care, and you should not use the information in place of a visit, call consultation, or the advice of your physician or other healthcare provider. If you believe you have any other health problem, or if you have any questions regarding your health or a medical condition, you should promptly consult your physician or other healthcare provider. Never disregard medical or professional advice, or delay seeking it, because of something you see, read, or hear on this App. Never rely on information on this App in place of seeking professional medical advice. If you believe you have a medical emergency, you should immediately call 911 or your healthcare provider.
“The Colonoscopy Helper is not liable or responsible for any advice, course of treatment, diagnosis or any other information, services or product you obtain through this App. Specifically, you should follow directions provided by your healthcare provider for specific directions for use and discontinuation of all of your medications. The information contained in this App should be considered only as a general guideline which may or may not apply to your specific medical circumstance and requirements.
“Health and medical information changes occur often. Therefore the information on this App should not be considered current, complete or exhaustive, nor should you rely on such information to recommend a course of treatment for you or any other individual. Reliance on any information provided on this App is solely at your own risk.
“As a user, you assume all responsibility and risk related to the use of the Colonoscopy Helper. Under no circumstances shall the Colonoscopy Helper or its contributors/employees or anyone else involved in creating or maintaining this app be liable for any DIRECT, INDIRECT, INCIDENTAL, SPECIAL or CONSEQUENTIAL DAMAGES, or LOST PROFITS that result directly or indirectly from the use or inability to use the app or that result directly or indirectly from mistakes, omissions, interruptions, deletion of files, viruses, errors, defects, or any failure of performance, communications failure, theft, destruction or unauthorized access.”
   In various embodiments of the invention, the wording of the disclaimer is not limited to the words or word sequences as disclosed above, and not limited to any particular language. However, in general, the disclaimer provides a medical information disclaimer and legal agreement for usage of the Medical Instruction App.

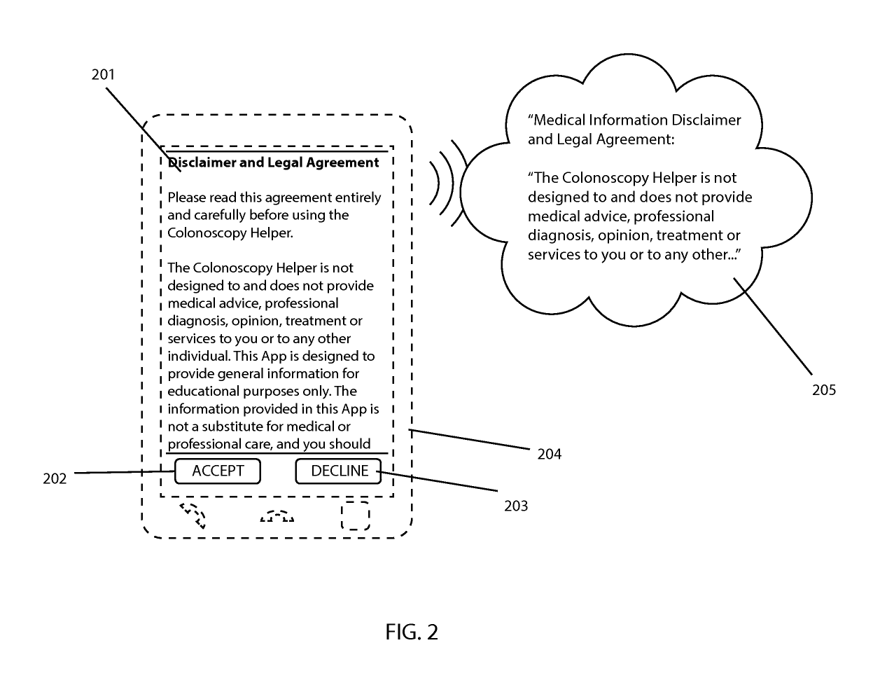

In the preferred embodiment of the invention, the output means for a number of features in the Medical Instruction App is through visual display 201 and/or audio presentation 205 of the information. In various embodiments of the invention, the output means for the disclaimer, and other features of the Medical Instruction App is through the visual display of said information 201 on a screen of a processor-based device 204, such as for example, a mobile communication device as illustrated in FIG. 2, commonly known in the prior art as a “smart phone” or “tablet.” In embodiments of the invention, the output means also comprises an audio presentation 205 of the disclaimer. In the preferred embodiment of the invention, the audio presentation 205 is a pre-recorded message. In other embodiments of the invention, said audio presentation is outputted by a text-to-speech program included in the operating systems of currently existing device-associated operating systems, such as for example, the “Text-to-Speech” feature in the Android® operating system, or “Accessibility” feature in the iOS® operating system. In the preferred embodiment of the invention, said audio message is outputted at the appropriate time, and/or the User can select to output the audio message at any time during the execution of the Medical Instruction App. In the preferred embodiment of the invention, said audio message is outputted, using, but is not limited to, the audio output features that are associated with processor-based devices, such as, for example, built-in-speakers, 3.5 mm phone connectors, and wireless audio output means like Bluetooth®.

In the preferred embodiment of the invention, the user may proceed with the use of the Medical Instruction App upon acceptance of and agreement to the disclaimer. In one embodiment of the invention, the Medical Instruction App displays the disclaimer, and the User may select to accept or deny the usage of the App by choosing prompts. For example, selection of ‘Accept’ 202, ‘Agree,’ or similar language enables the user to accept the terms of the disclaimer, and fully access the Medical Instruction App. Selecting ‘Decline’ 203, ‘Disagree,’ or similar language results in the User being unable to access the Medical Instruction App during the execution of the application program.

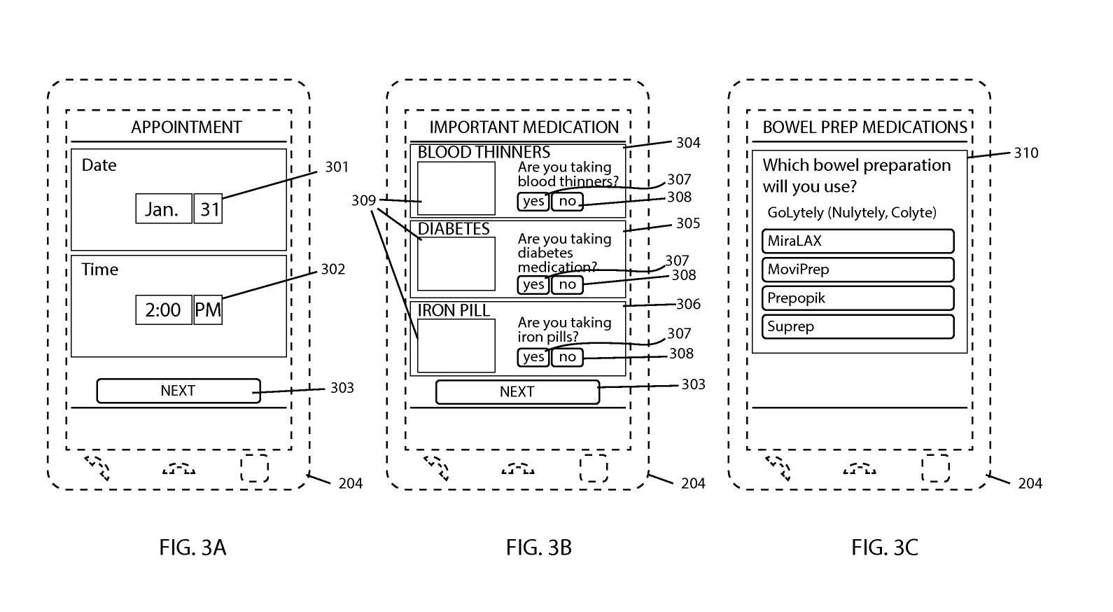

Upon User's acceptance of the terms of the disclaimer, the User has access to the Medical Instruction App. In the preferred embodiment of the invention, the Medical Instruction App further prompts the User to enter information 103 regarding the anticipated medical procedure. Said entered information comprises, but is not limited to, the type of medical examination, and the date and time 104 of the medical examination. As illustrated in FIG. 3A in the preferred embodiment of the invention, the Medical Instruction App prompts the User for information pertaining to the date 301 and time 302 of the upcoming colonoscopy examination. As illustrated in an embodiment of the invention in FIG. 3A and FIG. 3B, selecting “next” or “save” or similar Prompt to Continue and Save 303 stores User Input for the date and time 123 to a data storage medium 108 relating to the processor-based device 204.

In the preferred embodiment of the invention, the Medical Instruction App further prompts 103 the User for additional information pertaining to the upcoming medical procedure. Said additional information prompts comprise medication information 105 related to the User's anticipated medical procedure. In various embodiments of the invention, determining the type of medication that the User takes, and/or the medication that the User is currently taking, are relevant to the proceeding medical procedure preparation process, as the information displayed by the Medical Instruction App will change depending on the information entered by the User. Specifically, an embodiment of the invention prompts the user for specific medication information pertaining to a colonoscopy preparation process.

As illustrated in FIG. 3B The preferred embodiment of the invention prompts the User to select from relevant groups of medication, including, but not limited to blood thinners 304, diabetes medication 305, and iron supplements 306. For instance, User-disclosure of anti-coagulant blood thinning medication is important for a safe colonoscopy examination, as biopsies and/or polyp removal from Users taking said blood thinning medication can lead to excessive bleeding during the colonoscopy examination. In addition, User-disclosure of diabetes is important for the colonoscopy preparation process, as the fasting process during the colonoscopy preparation process may lead to blood sugar level complications. Moreover, User-discloser of iron supplements, or iron pills, is important for accurate diagnosis during the colonoscopy examination, as consumption of said iron supplements can darken the color of feces and possibly confound the colonoscopy examination. Therefore, the inventor has discovered that, in the preferred embodiment of the invention, prompts directed towards disclosing medication related to blood thinners, diabetes, and iron supplements effectively addresses a number of medication-related complications that may arise during a colonoscopy examination and associated preparation process. However, in various embodiments of the invention, the types of medication asked by embodiments of the Medical Instruction App is not limited to medication related to blood thinners, diabetes, and iron supplements. Other related medication also prompted in other embodiments include, but are not limited to fiber supplements, and non-steroidal anti-inflammatory agents that may also affect the colonoscopy examination and associated preparation process. Additionally, those that are experts in the field will understand that the information regarding other types of medication will be prompted in alternative embodiments of the Medical Instruction App tailored for other specific medical procedures.

In the preferred embodiment of the invention, a User-selectable prompt is displayed, as illustrated in FIG. 3B, that enables the User to select whether the User is currently taking blood thinners, diabetes medication, and/or iron supplements. In the preferred embodiment of the invention, “Visual Aids”, comprising photos, logos, illustrations, pictures, or other visual information that can aid a User to understand the process related to a medical procedure, are included. In the preferred embodiment of the invention, Visual Aids 309, such as for example, those related to blood thinners, diabetes medication, and/or iron supplements are also displayed. In the preferred embodiment of the invention, the names of commonly available medication are displayed such that the User can easily recognize the medication and indicate whether the User is taking said medication. In the preferred embodiment of the invention, specific blood-thinning medication that are displayed include, but are not limited to Coumadin®, Effient®, Eliquis®, Lovenox®, Plavix®, and Xarelto®. In the preferred embodiment of the invention, the User can select “yes” 307 or “no” 308 to taking blood thinners, diabetes medication, and/or iron supplements, by selecting the appropriate area on the graphical interface of the Medical Instruction App. In the preferred embodiment of the invention, selection of “yes” 307 or “no” 308 to each prompt, and/or selecting “next” or “save” 302 or similar prompts stores the User Input for Medication Information 124 to a data storage medium 108 relating to the processor-based device 204.

In the preferred embodiment of the invention, the Medical Instruction App prompts the User for additional information pertaining to the upcoming medical procedure. Said information prompts comprise Bowel Preparation Medication 106 related to the User's anticipated colonoscopy examination. Said “Bowel Preparation Medication”, referred to herein, are drugs that help to clear the colon for colonoscopy, and include, but are not limited to Golytely®, Nulytely®, Colyte®, Miralax®, Moviprep®, Prepopik®, and Suprep® in the preferred embodiment of the invention. In an embodiment of the invention, the Medical Instruction App displays a User Selectable Bowel Preparation Medication Prompt 310, as illustrated in FIG. 3C. In the preferred embodiment of the invention, selection of a Bowel Preparation Medication from the User Selectable Bowel Preparation Medication Prompt stores the User Input for Bowel Preparation Medication 125 to a data storage medium 108 relating to the processor-based device 204.

In the preferred embodiment of the invention, the “Scheduling Algorithm” 107, as referred to herein, determines the scheduled dates and times of the proceeding Reminder or plurality of Reminders. In the preferred embodiment of the invention, said “Reminder” and “Sub-Reminder” as referred to herein, are scheduled events that bring necessary commitments regarding the upcoming medical procedures to the attention of the User. In general, the preferred embodiment of the invention comprises a Scheduling Algorithm 107 that calculates said dates and times of the proceeding Reminder or plurality of Reminders, using User Input for Date and Time 123, User Input for Medication Information 124, User Input for Bowel Preparation Medication 125, and the date and time of the processor-based device 204. In the preferred embodiment of the invention, said Reminders are related to text-based, visual-based, and audio-based outputs to enable the User to prepare for the upcoming medical procedure.

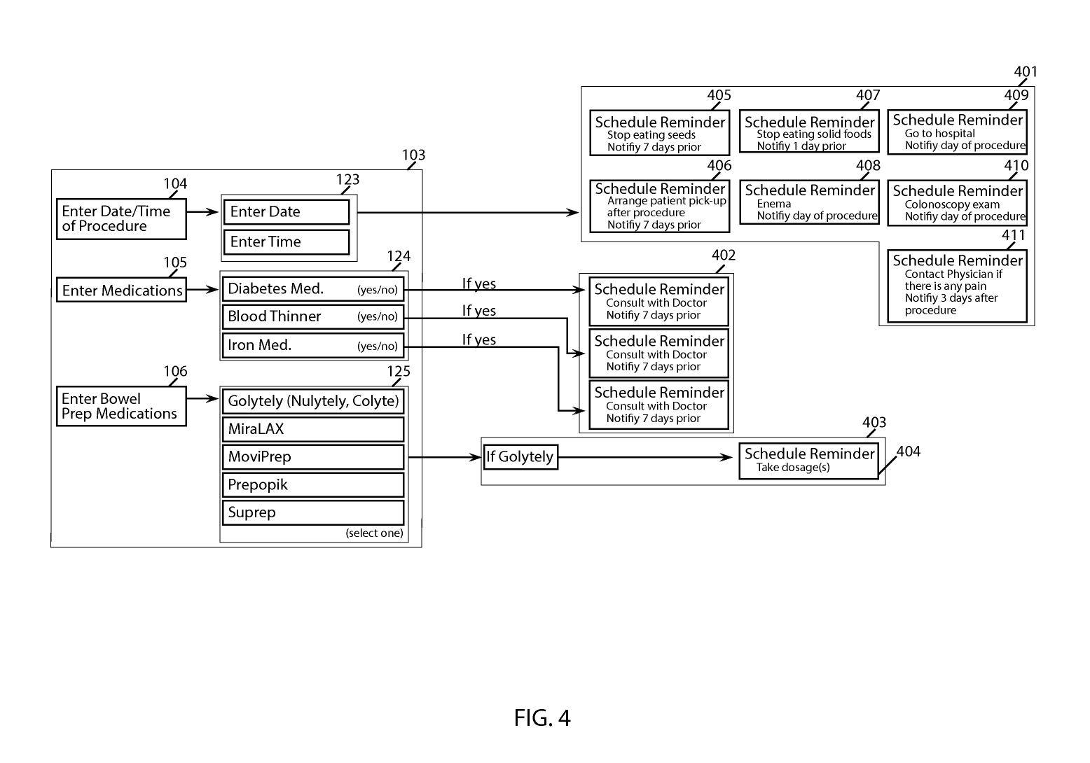

The workings of the Scheduling Algorithm 107 in the preferred embodiment of the invention can be visualized by a Flow Diagram of the Scheduling Algorithm, as illustrated in FIG. 4. In general, in the preferred embodiment of the invention, Reminders serve to notify the User of the various steps that help to prepare the User for the upcoming Medical Procedure. In the preferred embodiment of the invention, the Scheduling Algorithm 107 outputs a set of Date and Time Reminders 401 on certain dates and times based on the Prompt and User Input for information regarding the anticipated medical procedure 103. In the preferred embodiment of the invention, said Date and Time Reminders 401 comprises notifications that aid the User. In the preferred embodiment of the invention, the Date and Time Reminders 401 include, but are not limited to the following items: 1) a Reminder to stop eating foods that can result in indeterminate diagnoses 405, said foods in general containing seeds, said foods comprising cucumber, grapes, kiwi, melon, nuts, popcorn, tomato, and watermelon; 2) a Reminder to arrange a pickup for the User 406; 3) a Reminder to stop eating solid foods 407; 4) a Reminder to perform an enema 408; 5) a Reminder to go to the location of the upcoming medical procedure 409; 6) a Reminder of the time on the date and time of the medical procedure 410; and 7) a Reminder to follow up with the physician after the medical procedure 411.

Those skilled in the art will understand that the Reminders may occur at various dates and times before and after the medical procedure. However, in the preferred embodiment of the invention, the Reminder to stop eating foods that can result in indeterminate diagnoses 405 occurs within 14 days before the User Input for Date and Time 123 of the upcoming medical procedure. In the preferred embodiment of the invention, the Reminder to arrange a pickup for the User 406 occurs within 14 days before the User Input for Date and Time 123 of the upcoming medical procedure. In the preferred embodiment of the invention, the Reminder to stop eating solid foods 407 occurs within 7 days before the User Input for Date and Time 123 of the upcoming medical procedure. In the preferred embodiment of the invention, the Reminder to perform an enema 408 occurs within 2 days before the User Input for the date and time 123 of the upcoming medical procedure. In the preferred embodiment of the invention, the Reminder to go to the location of the upcoming medical procedure 409 occurs within 1 day before the User Input for Date and Time 123 of the upcoming medical procedure. In the preferred embodiment of the invention, the Reminder of the time on the date and time of the medical procedure 410 occurs on the day of the User Input for Date and Time 123 of the upcoming medical procedure. In the preferred embodiment of the invention, the Reminder to follow up with the physician after the medical procedure 411 occurs within 7 days after the User Input for Date and Time 123 of the upcoming medical procedure.

Furthermore, in the preferred embodiment of the invention, the Scheduling Algorithm 107 outputs a set of Medication Information Reminders 402 on certain dates and times based on the Prompt and User Input for information regarding the anticipated medical procedure 103, as illustrated in FIG. 4. In general, the Medication Information Reminders 402 aids the User to determine whether further action is necessary if the User is currently taking certain medication, said medication comprising blood thinners, diabetes medication, and/or iron supplements. In the preferred embodiment of the invention, the Scheduling Algorithm 107 outputs Medication Information Reminders 402 based on the User Input of selecting “yes” to User Input for Medication Information 124. In the preferred embodiment of the invention, said Medication Information Reminders 402 output from the Scheduling Algorithm 107 is dependent on pre-defined conditional statements. An example of said conditional statement includes, for example, “if the User Input is “yes” or “true” for diabetes medication, schedule a Reminder seven days prior to the colonoscopy examination, said Reminders comprising: review important medication information with my doctor regarding diabetes medication.” In the preferred embodiment of the invention, the Medical Instruction App outputs a Medication Information Reminders 402 if the User Input for Medication Information 124 is “yes” or “true for blood thinners, diabetes medication, and/or iron supplements. In the preferred embodiment of the invention, the Medication Information Reminders 402 occurs within 14 days before the User Input for the date and time 123 of the upcoming medical procedure.

Moreover, in the preferred embodiment of the invention, the Scheduling Algorithm 107 outputs a Bowel Preparation Medication Reminder 404 on certain dates and times based on the Prompt and User Input for information regarding the anticipated medical procedure 103, as illustrated in FIG. 4. In general, the Bowel Preparation Medication Reminder 404 notifies the User to take certain medication related to the User Input for Bowel Preparation Medication 125. In one example of an embodiment of the invention, wherein a user selects Golytely® from the User Selectable Bowel Preparation Medication Prompt 310, as illustrated in FIG. 3C, the Bowel Preparation Medication Reminder 404 comprises notifications that are specific for Golytely® 403. In the preferred embodiment of the invention, said notifications specific for Golytely® include, for example, a number of Sub-Reminders to take the required doses related to the Golytely® Bowel Preparation Medication. In the preferred embodiment of the invention, the set of Reminders and Sub-Reminders output from the Scheduling Algorithm 107 is dependent on pre-defined conditional statements. An example of said conditional statement includes, for example, “if the User Input is true for Golytely®/Dulcolax®, schedule a set of Reminders one day prior to the colonoscopy examination, said Reminders comprising: 1) take the first dose of Dulcolax® at 1:00 pm; 2) take the second dose of Dulcolax® at 3:00 pm; etc.” In general, in the preferred embodiment of the invention, the Bowel Preparation Medication Reminder 404 comprises various Sub-Reminders that occurs before the User Input for Date and Time 123. Those skilled in the art will understand that the Bowel Preparation Medication Reminder 404 and related Sub-Reminders will vary depending on the User Input for Bowel Preparation Medication 125.

In the preferred embodiment of the invention, the Reminder to follow up with the physician after the medical procedure 411 occurs within 7 days after the User Input for Date and Time 123 of the upcoming medical procedure. In general, there is a need for a patient to follow up with the physician after a colonoscopy examination as to treat complications that have resulted from said colonoscopy examinations. For instance, a patient experiencing abdominal pain, rectal bleeding, fever, and chills after the colonoscopy examination may need to be treated for those symptoms. In the preferred embodiment of the invention, the Reminder to follow up with the physician after the medical procedure 411 comprises a Reminder or a plurality of Reminders that contains a message for the User to call the physician after the Medical Procedure if there are adverse effects after undergoing the Medical Procedure. Having this feature in the preferred embodiment of the invention is advantageous over prior art methods, because unlike prior art methods wherein physicians and/or healthcare professionals call the patient to follow up with the Patient regarding the Medical Procedure, a User of the Medical Instructions App is automatically reminded to contact said User's physician. Therefore, the Reminder to follow up with the physician after the medical procedure 411 feature in the preferred embodiment of the invention not only saves time and resources of the physician and related medical professionals, it also reminds the User to be aware of specific symptoms that said User may experience after a Medical Procedure in order to avoid medical complications related to said Medical Procedure.

Those skilled in the art will understand that in the preferred embodiment of the invention, the Reminders and Sub-Reminders referred to herein are scheduled on various dates and times before and after the medical procedure to aid the User in undertaking the medical procedure. Those skilled in the art will also understand that in embodiments of the invention, the Reminders and Sub-Reminders are not limited to the dates and times mentioned herein.

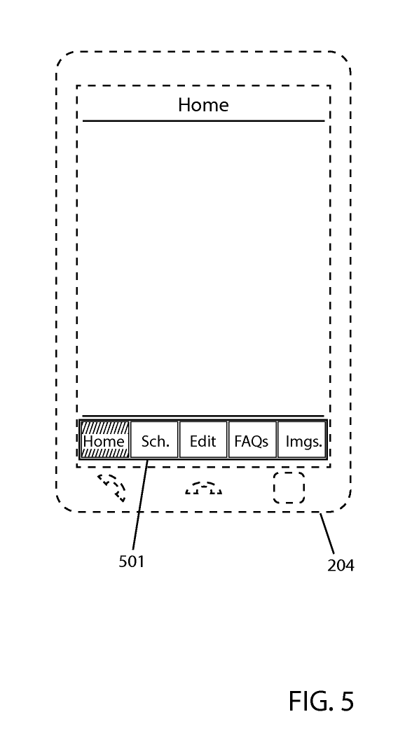

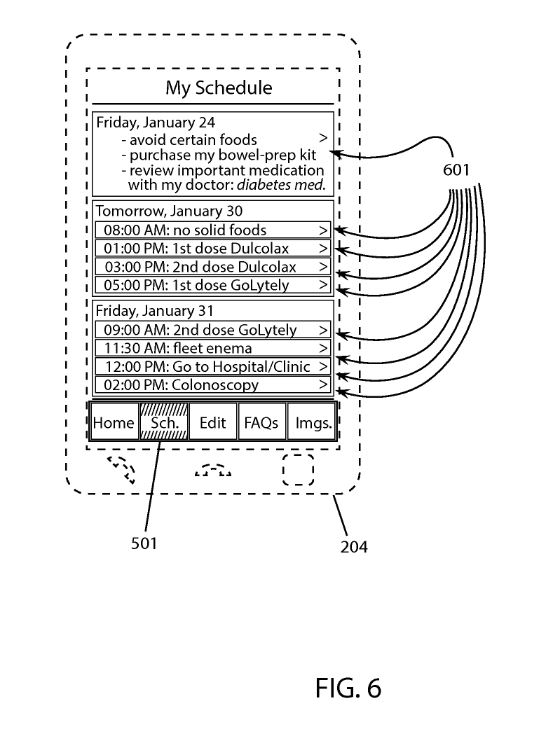

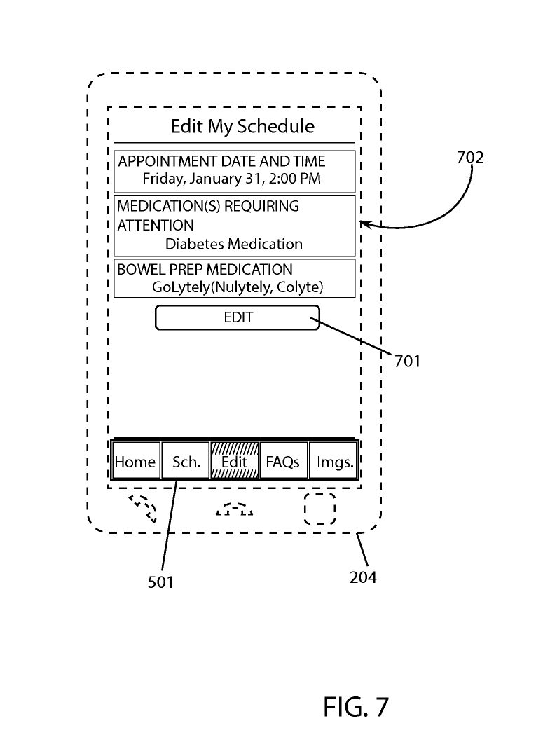

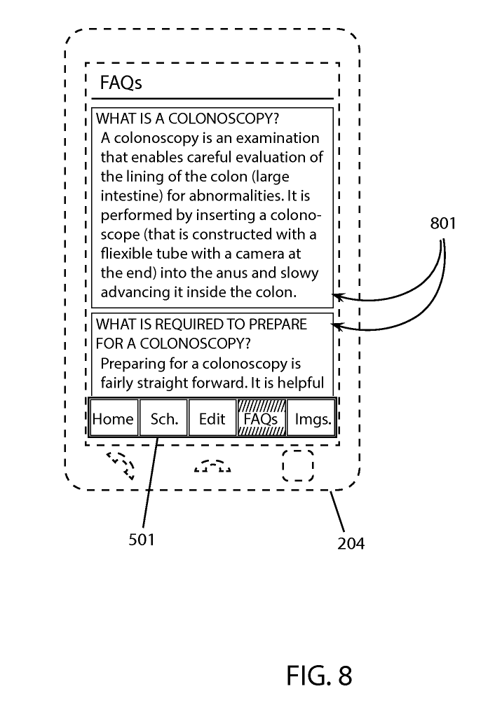

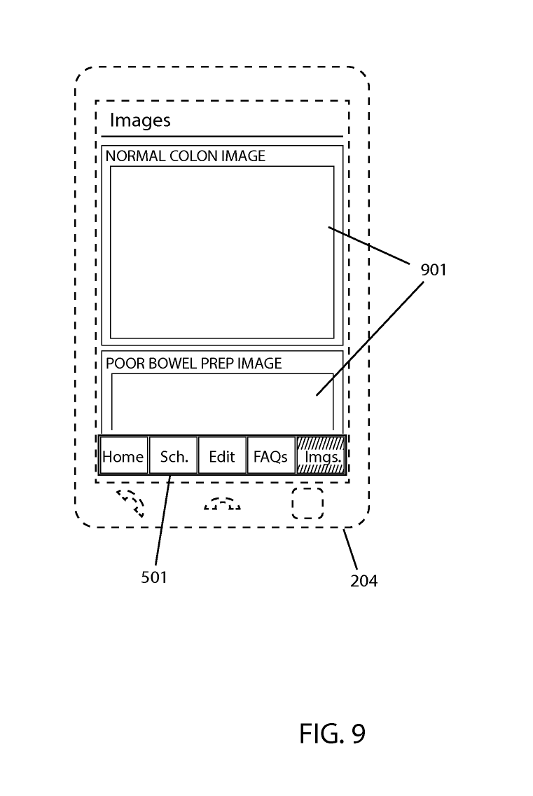

In the preferred embodiment of the invention, the User will be able to interact with the various informational materials in the Medical Instruction App. The various informational materials are accessible through a Menu 109 in the preferred embodiment of the invention. Said informational materials accessible through the Menu 109 include, but is not limited to the Home 110, My Schedule 111, Edit My Schedule 112, FAQs 113, and Images 114. As illustrated in an embodiment of the invention in FIG. 5, FIG. 6, FIG. 7, FIG. 8, and FIG. 9 the Menu Interface 501 is displayed on the Medical Instruction App. In the preferred embodiment of the invention, the Menu Interface 501 comprises “Menu Items, wherein said Menu Items are User-selectable text, images, and/or icons, that enable a user to select further informational material from the Menu Interface 501. In the preferred embodiment of the invention, Menu Items represent the Home 110, My Schedule 111, Edit My Schedule 112, FAQs 113, and Images 114 found within a Menu 109. As illustrated in an embodiment of the invention in FIG. 5, FIG. 6, FIG. 7, FIG. 8, and FIG. 9, selection of a Menu Item in the Menu Interface 501 results in said Menu Item displaying a different visual property, said different visual property comprising a different color, shade, text, or marking as compared to the rest of said Menu Interface 501. In the preferred embodiment of the invention, selection of a Menu Item from the Menu Interface 501 enables User-access to various informational material comprising the Home 121, My Schedule 115, Edit My Schedule 121, FAQs 116, and Images 117 informational material. In other embodiments of the invention, the number and types of Menu Items found in the Menu Interface 501 is not limited to those referred to herein, and those skilled in the art will understand that other informational material that helps a User to understand the upcoming Medical Procedure may be included within the menu 109.

In an embodiment of the invention, as illustrated in FIG. 5, User-selection of the Home 110 informational material from the Menu Interface 501 enables the User to access the Home Informational Material 122. In the preferred embodiment of the invention, the Home Informational Material 122 comprises, but is not limited to a graphic related to the Medical Instruction App, and text-based information regarding the Medical Instruction App.

In an embodiment of the invention, User-selection of My Schedule 111 from the Menu Interface 501 enables the User to access the schedule of Reminders tailored to the Medical procedure, as illustrated in FIG. 6. In an embodiment of the invention, selection of My Schedule 111 from the Menu Interface 501 recalls information from the Memory Storage 108, said information comprising an output from the Scheduling Algorithm 107, and displays said information as an interactive interface that displays My Schedule 115 comprising a set of Reminders and/or Sub-Reminders 601 calculated by the Scheduling Algorithm 107.

In an embodiment of the invention, User-selection of Edit My Schedule 112 from the Menu Interface 501 displays a brief overview of the User's Current Input Information 702, as illustrated in FIG. 7. Based on the User's Current Input Information 702, a User is empowered to change User information regarding the anticipated medical procedure 103 in the preferred embodiment of the invention. As illustrated in an embodiment of the invention in FIG. 7, selecting “Edit” 701 or “change” or similar prompts, results in the Medical Instruction App to re-execute 121 the prompt for User information regarding the anticipated medical procedure 103, enabling the user to edit and/or re-enter said User information. In an embodiment of the invention, selection of Edit My Schedule 112 prompts the User to enter the date and time of the medical examination 104, the User medication information 105, and the Bowel Preparation Medication 106, as illustrated in FIG. 3A, FIG. 3B, and FIG. 3C, respectively. Moreover, in the preferred embodiment of the invention, the Scheduling Algorithm 107 processes the entered User information regarding the anticipated medical procedure 103 and outputs results from the Scheduling Algorithm on a data storage medium 108.

In an embodiment of the invention, User-selection of FAQs 113 from the Menu Interface 501 displays a number of written informational content related to the upcoming Medical Procedure, such as for example, Frequently Asked Questions and corresponding answers to said Frequently Asked Questions 801, as illustrated in FIG. 8. In the preferred embodiment of the invention, the Frequently Asked Questions 801 comprises written informational content related to a colonoscopy. Those skilled in the art will understand that the Frequently Asked Questions is provided by the Medical Instruction App to further educate the User of the colonoscopy procedure.

In an embodiment of the invention, User-selection of Images 114 from the Menu Interface 501 displays a number of Visual Aids related to the Medical Procedure 901, such as for example, images related to the Medical Procedure, as illustrated in FIG. 9. In the preferred embodiment of the invention, Visual Aids related to the Medical Procedure 901 comprises photographs and illustrations, such as for example, photographs of ideally prepared colons for colonoscopy, photographs of poorly-prepared colons for colonoscopy, and photographs of colon polyps. Those skilled in the art will understand that the visual informational content is provided by the Medical Instruction App to educate the User of the upcoming Medical Procedure.

In general, in the preferred embodiment of the invention, a Reminder, a plurality of Reminders, a Sub-Reminder, and a plurality of Sub-Reminders aid in notifying the User events related to upcoming medical procedure. In the preferred embodiment of the invention, Said Reminders and Sub-Reminders notify the User through a processor-based device 204 at designated dates and times as assigned by the Scheduling Algorithm 107. In an embodiment of the invention, said Reminders or Sub-Reminders are displayed through “Reminder Notifications” 118. In the preferred embodiment, said Reminder Notifications 118 comprises, for example, “Push Notifications” found in the prior art related to the Android® operating system, or iOS® operating system, e-mail notifications found in the prior art, and SMS® or MMS® messaging found in the prior art. In the preferred embodiment, said Reminder Notifications 118 further comprises output of a Reminder, a plurality of Reminders, a Sub-Reminder, and a plurality of Sub-Reminders to software-related applications associated with processor-based device, such as, for example, software-related Calendars found in the prior art. In the preferred embodiment of the invention, said Reminder Notifications 118 further comprises output of a Reminder, a plurality of Reminders, a Sub-Reminder, and a plurality of Sub-Reminders to other devices, said other devices including, but not limited to other processor-based devices, data storage media, a cloud storage, and other software or software-related inventions. In the preferred embodiment of the invention, said output means occurs through a “Syncing Module” 120. Said Syncing Module 120 is a software-related application that communicates with other devices, in the preferred embodiment of the invention. In the preferred embodiment of the invention, said Syncing Module 120 enables the User to be reminded of a Reminder, a plurality of Reminders, a Sub-Reminder, and a plurality of Sub-Reminders through other devices found in the prior art.

In the preferred embodiment of the invention, prior art visual display means comprises, for example, text-based notifications on a screen associated with a processor-based device 204. In the preferred embodiment of the invention, prior art audio display means comprises, for example, sound-based notifications through a speaker associated with a processor-based device 204. In general, in the preferred embodiment, the Reminder Notifications 118 comprises a processor-based device that notifies the User of a Reminder, a plurality of Reminders, a Sub-Reminder, and/or a plurality of Sub-Reminders through prior art visual display means and/or prior art audio display means associated with said processor-based device 204. Therefore, in the preferred embodiment of the invention, the Reminder Notifications 118 aid a User to take action regarding a Reminder, a plurality of Reminders, a Sub-Reminder, and/or a plurality of Sub-Reminders, for example, to enable a User to not have to keep track of the complex procedure associated with a colonoscopy preparation process.

Additionally, in the preferred embodiment of the invention, a User may interact with an interface to obtain further information related to the medical procedure, such as a colonoscopy. In the preferred embodiment of the invention, the “Text, Audio, and/or Visual Display” 119, as referred to herein, enables a User to interact with said information. In the preferred embodiment of the invention, the Text, Audio, and/or Visual Display 119 relates to a User-interactive means to see, hear, read, or otherwise interact with information related to the Medical Instruction App. In the preferred embodiment of the invention, the output means relates to visual display and/or audio display of the information. In various embodiments of the invention, the output means is through the visual display of said information on a screen of a processor-based device 204. In embodiments of the invention, the output means also comprises an audio presentation of information. In the preferred embodiment of the invention, the audio presentation 205 is a pre-recorded message. As illustrated in an embodiment of the invention in FIG. 1 the Text, Audio, and/or Visual Display 119 is related to a number of features, including, but not limited to the Home Informational Material 122, My Schedule Informational Material 115, FAQs Informational Material 116, Images Informational Material 117, and Reminders and Sub-Reminders 601.

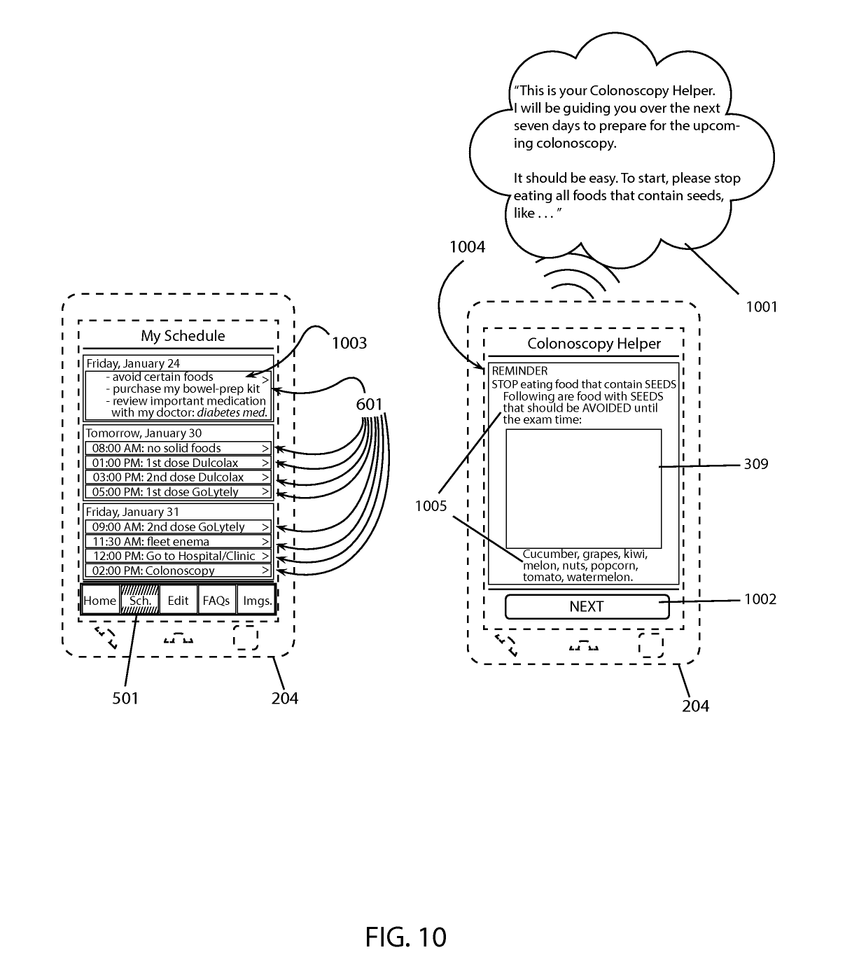

As visualized in the preferred embodiment of the invention in FIG. 10, the Text, Audio, and/or Visual Display 119 enables a User to interact with, and/or obtain information regarding a Medical Procedure. In the preferred embodiment of the invention, the Text, Audio, and/or Visual Display 119 displays information, such as, for example, Text-Based Aids 1005, Visual Aids 309, and Audio Presentation 1001 to aid Users in obtaining information regarding a colonoscopy and/or associated colonoscopy preparation process. For example, in an embodiment of the invention, a User can select from various Interactive Selection Prompt for a Reminder 601 to access the Text, Audio, and/or Visual Display 119 associated with a specific Interactive Selection Prompt for a Reminder 601. In one particular example, in an embodiment of the invention, User-selection of Interactive Selection Prompt Example A 1003 results in display of the Text, Audio, and/or Visual Display Example A 1004 related of said Interactive Selection Prompt Example A 1003. In an embodiment of the invention, said Text, Audio, and/or Visual Display Example A 1004 would display Text-Based Aids 1005, Visual Aids 309, and Audio Presentation 1001 specific for the User-selected Interactive Selection Prompt Example A 1003. Additionally, User-selection of a Prompt to Continue 1002 would enable a user to further obtain additional information, for example, by interacting with an alternate Text, Audio, and/or Visual Display, in an embodiment of the invention. Optionally, User-selection of a Prompt to Continue 1002 would enable a User to return to the one of the other steps, features, menus, or informational material associated with the Medical Instruction App.

In the preferred embodiment of the invention, the Medical Instruction App comprises a number of features that allow access to certain information related to the Medical Instruction App only through payment. Users skilled in the art will appreciate that an embodiment of the invention therefore may take place through adoption of a “Freemium” payment model, whereby the actual download of the application and some base functionalities associated with the application are free, but also whereby some other more advanced features associated with the application require additional payment. In various embodiments of the invention, the Medical Instruction App requires payment for a User to access content relating to other Bowel Preparation Medication, for example, for using Nulytely®, Colyte®, Miralax®, Moviprep®, Prepopik®, and Suprep®. In said embodiments of the invention, a User will be prompted to make payment after selecting, for example, prompts for Nulytely®, Colyte®, Miralax®, Moviprep®, Prepopik®, or Suprep® at the User Selectable Bowel Preparation Medication Prompt 310. Selection and payment of the appropriate fees associated with other Bowel Preparation Medication such as Nulytely®, Colyte®, Miralax®, Moviprep®, Prepopik®, or Suprep® results in Bowel Preparation Medication Reminder related to said Bowel Preparation Medication to be displayed in the Medical Instruction App.

The above said method is provided for preparing a patient for a medical procedure for colonoscopy using an application on a processor-based device but also can be used for many other medical procedures such as endouroscopic procedure, other instructional or educational tasks.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

The present systems, methods, means, and enablement are not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

I claim:

1. A method to prepare a patient for a medical procedure, comprising:
Scheduling a time for a medical procedure;
Storing the time for the medical procedure within a storage medium accessible via a network;
Reminding a patient of the medical procedure at a time prior to the medical procedure.

2. The method of claim 1, whereby the reminding step takes place by delivering a message to a mobile device utilized by said patient and displaying said message.

3. The method of claim 1, further comprising:
Displaying an option to view a subset of informational materials relevant to the medical procedure within a menu;
Receiving a subset of informational materials selection signal indicative of the selection device pointing at selected subset of informational materials selection signal from the set of subsets of informational materials, whereby said informational materials selection signal indicates a command to display the selected subset of informational materials; and
In response to the subset of informational materials selection signal, displaying visual aids relevant to the medical procedure.

4. A method of providing instructions to assist a patient while preparing for a medical procedure, comprising:
Identifying the steps a patient must take in preparation for a procedure;
Determining the point in time at which a patient much take said steps;
Displaying messages on the screen of a processor-based device at predetermined points in time with instructions to take said steps;

5. The method of claim 4, further comprising
Delivering a reminder message to a mobile computing device utilized by a patient;
Receiving a confirmation signal from a patient that the patient has performed the step indicated in the reminder message, whereby said confirmation signal indicates a command to the mobile computing device to transmit confirmation that a patient has performed an action to a physician via a connected medical records system;
Transmitting the confirmation signal to a connected medical records system; and
Storing confirmation that the patient has performed the step indicated in the reminder message.

6. In a mobile computer system having a graphical user interface including a display and a selection device, a method of providing and selecting from a menu of calendar activities related to preparation for a colonoscopy procedure on a display, the method comprising:
Retrieving a set of calendar entries for the menu, each of the calendar entries representing a colonoscopy preparation characteristic;
Displaying a set of calendar entries on the display;
Receiving a calendar entry selection signal indicative of the selection device pointing at selected calendar entry from the set of calendar entries, whereby the calendar entry selection signal indicates a command to the mobile computing device to play audio instructions through the mobile computer system related to the specific action a patient must perform in preparation for the colonoscopy and to display a screen having a photo of the medication that a patient must take or having a photo of the activity the patient must perform, text instructions associated with the medication a patient must take or the activity that a patient must perform, and a confirmation button;
In response to the calendar entry selection signal signal, playing audio instructions through the mobile computer system related to the specific action a patient must perform in preparation for the colonoscopy;
In response to the calendar entry selection signal, displaying a screen having a photo of the medication that a patient must take or having a photo of the activity the patient must perform, text instructions associated with the medication a patient must take or the activity that a patient must perform, and a confirmation button; and
Receiving a confirmation signal upon the selection of the confirmation button, indicative of confirmation that a patient has taken the medication indicated on the screen having the photo of the medication and text instructions associated with the medication, or indicative of confirmation that a patient has performed the activity indicated on the screen having the photo of the activity and text instructions associated with the activity, or receiving a nonconfirmation signal upon failure to select the confirmation button.

7. The method of claim 6, further comprising:
Delivering the confirmation signal to a system accessible by a medical professional.

8. The method of claim 6, further comprising:
Delivering the nonconfirmation signal to a system accessible by a medical professional;
In response to receiving the nonconfirmation signal, a medical professional contacting a patient to follow up and alter the patient's colonoscopy preparation plan or reschedule a colonoscopy procedure, as necessary.
